(19) United States
(12) Patent Application Publication
(10) Pub. No.: US 2024/0140969 A1
(43) Pub. Date: May 2, 2024

(54) ANTHRAQUINONE-BASED COVALENT ORGANIC FRAMEWORKS

(71) Applicant: The Hong Kong University of Science and Technology, Hong Kong (CN)

(72) Inventors: Yoonseob KIM, Hong Kong (CN); Chen LI, Hong Kong (CN); Gerald Siu Hang POON HO, Hong Kong (CN); Jun HUANG, Hong Kong (CN); Gitaek BANG, Hong Kong (CN)

(21) Appl. No.: 18/485,373

(22) Filed: Oct. 12, 2023

Related U.S. Application Data
(60) Provisional application No. 63/415,304, filed on Oct. 12, 2022.

(51) Int. Cl. C07F 7/08; H01M 10/056

(52) U.S. Cl. CPC C07F 7/0816; H01M 10/056; H01M 10/0525; H01M 2300/0065

(57) ABSTRACT

Anthraquinone-based covalent organic frameworks; methods for preparing anthraquinone-based covalent organic frameworks; solid electrolyte interphases including the anthraquinone-based covalent organic frameworks; and electrochemical devices including the solid electrolyte interphases. The solid electrolyte interphases can exhibit enhanced transport of Li⁺. Battery cells including the solid electrolyte interphase exhibit improved reversible capacities.

### CROSS-REFERENCE TO RELATED APPLICATIONS

The present application claims priority from U.S. Provisional Patent Application No. 63/415,304, filed on Oct. 12, 2022, which is hereby incorporated by reference in its entirety.

### TECHNICAL FIELD

The present disclosure relates to anthraquinone-based covalent organic frameworks useful as solid electrolyte interphases, methods of preparation, and electrochemical devices comprising the same.

### BACKGROUND

In the past two decades, lithium-ion batteries have proven to be a viable way to store energy for various consumer electronic applications, such as portable electronics, electric vehicles, and grid-scale storage. The relatively low energy density of the system has been overcome by the lithium metal battery (LMB) systems, where the anode is Li metal. The LMBs show the highest theoretical energy density of 3,861 mAh g⁻¹. Although lithium metal has been proven useful as an anode in the Li secondary battery, the severe lithium dendrite growth and unstable solid electrolyte interphase (SEI) at Li-electrolyte interface have seriously impeded the development of LMBs. Tremendous efforts have been made to overcome these problems by suppressing the dendrite growth on the anode. Among these methods, constructing a stable artificial SEI layer on Li metal anode proved to be an effective strategy as it stabilizes the anode surface and prevents undesirable side reactions between Li metal and electrolytes.

An ideal SEI should possess electrochemical and chemical stability to avoid side reactions between the Li metal and liquid electrolyte, a robust and homogeneous structure to suppress dendrite growth and regulate the Li⁺ flux distribution, and high ionic conductivity to transport Li⁺. Furthermore, the Li⁺ diffusion and deposition are a coupled process that should be significantly considered to inhibit the dendrite growth. However, studies on the diffusion limitation in LMBs are less well studied. According to Sand's theory, the cation depletion during electrodeposition breaks electrical neutrality and builds up space charge at the plated electrode surface, triggering parasitic reactions and developing branches of metal deposition. ¹² In most cases, liquid electrolytes have a low Li transference number (t_{Li}+), and the majority of the total ionic conductivity is attributed to the small-size anion transport. Therefore, this low fraction of the entire ionic conduction carried by Li⁺ results in Li⁺ deficiency during cycling. Thus, coating the Li metal anode with electrolyte-based interphases, which rapidly and exclusively transport Li⁺, is an effective method to avoid Li⁺ depletion and the dendrite formation on the anode while keeping the battery performance high.

Covalent organic frameworks (COFs) with an installed ion conduction moiety can be used as electrolyte-based interphase materials, as they are known to suppress dendrites and conduct ions. In this sense, COFs with redox-active moieties have been studied as the redox groups can facilitate the transfer of electrons and cations upon the redox changes (FIG. 1a). In one example, redox-active 2,6-diaminoanthraquinone moieties were introduced into 2D COFs and showed long-term reversible electrochemical processes, excellent chemical stability, and high capacitance. In another example, the same type of β-ketoenamine-linked COFs were used as an anode for sodium-ion batteries, which exhibited high capacity and stable battery performance. Recently, pyrene-tetraone-based 2D COFs were reported to exhibit high specific power of 184 kW kg⁻¹ and reversible capacity of 225 mAh g⁻¹ at 0.1 A g⁻¹ for aqueous zinc-organic batteries. Another promising strategy is to introduce ionic groups to the COF backbones. The so-called ionic covalent organic frameworks have emerged as attractive materials for solid-state electrolytes (FIG. 1a). The coaxially aligned pore channels enable rapid Li⁺ conduction through the abundant ionic sites with exclusive and uniform Li⁺ flux for high conductivity while inhibiting the dendrite formation. At present, the reported room-temperature ionic conductivity of optimized COF electrolyte can reach the order of mS cm⁻¹. So far, the imidazolate-based COFs show the highest value of 7.2 mS cm⁻¹ at room temperature, which is close to the acceptable range of solid-state electrolytes. In 2017, the first hexacoordinated 2D silicate COFs were reported, wherein the reversibility of Si—O bond formation led to the silicate 2D COFs having crystallinity and high porosity. Recently, this silicate COF was used as the electrolyte interphase for the anode in the LMB to show ionic conductivity of 3.7 mS cm⁻¹ and AQ-Si-COFs of 0.82 while successfully inhibiting the dendrite growth.

Nonetheless, there still exists a need to develop improved solid electrolyte interphases that overcome at least some of the challenges noted above.

### SUMMARY

Provided herein are anthraquinone-based COF structures that include both anionic sites and redox active moieties. This simple and effective design includes anthraquinones as linkages of the backbone and redox active sites and silicates or germanates as the anionic sites, which are hereinafter referred to anthraquinone silicate COFs (AQ-Si-COFs) and anthraquinone germanate COFs (AQ-Ge-COFs). More particularly, redox-active 2,3,6,7-tetrahydroxy-9,10-anthraquinone (THAQ) was used as a building block for the silicate or germanate COFs, where hypervalent silicates or germanates connect anthraquinones in three-fold symmetry (FIGS. 1b and 1c).

In a first aspect, provided herein is an anthraquinone-based covalent organic framework (AQ-COF) comprising a first repeating unit and a second repeating unit, wherein the first repeating unit comprises a moiety of Formula 1:

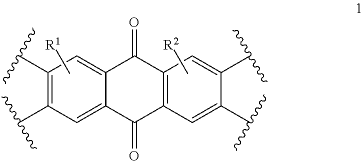

or a reduced form thereof, wherein each of R¹ and R² is independently hydrogen, C₁-C₃ alkyl, halide, nitro, or nitrile; and the second repeating unit comprises a moiety for Formula 2:

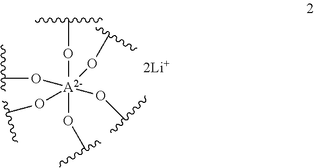

or a reduced form thereof, wherein A is Si or Ge.

In certain embodiments, the first repeating unit and the second repeating unit are present in the AQ-COF in a ratio of 1:1.9 to 1:2.1, respectively.

In certain embodiments, each of R¹ and R² is independently hydrogen, fluoride, nitro, or nitrile.

In certain embodiments, each of R¹ and R² is hydrogen.

In certain embodiments, A is Si.

In certain embodiments, the reduced form of the moiety of Formula 1 further comprises one electron and one Li⁺ or two electrons and two Li⁺.

In certain embodiments, the reduced form of the moiety of Formula 2 further comprises one electron and one Li⁺, two electrons and two Li⁺, or three electrons and three Li⁺.

In certain embodiments, the AQ-COF comprises a repeating unit of Formula 3:

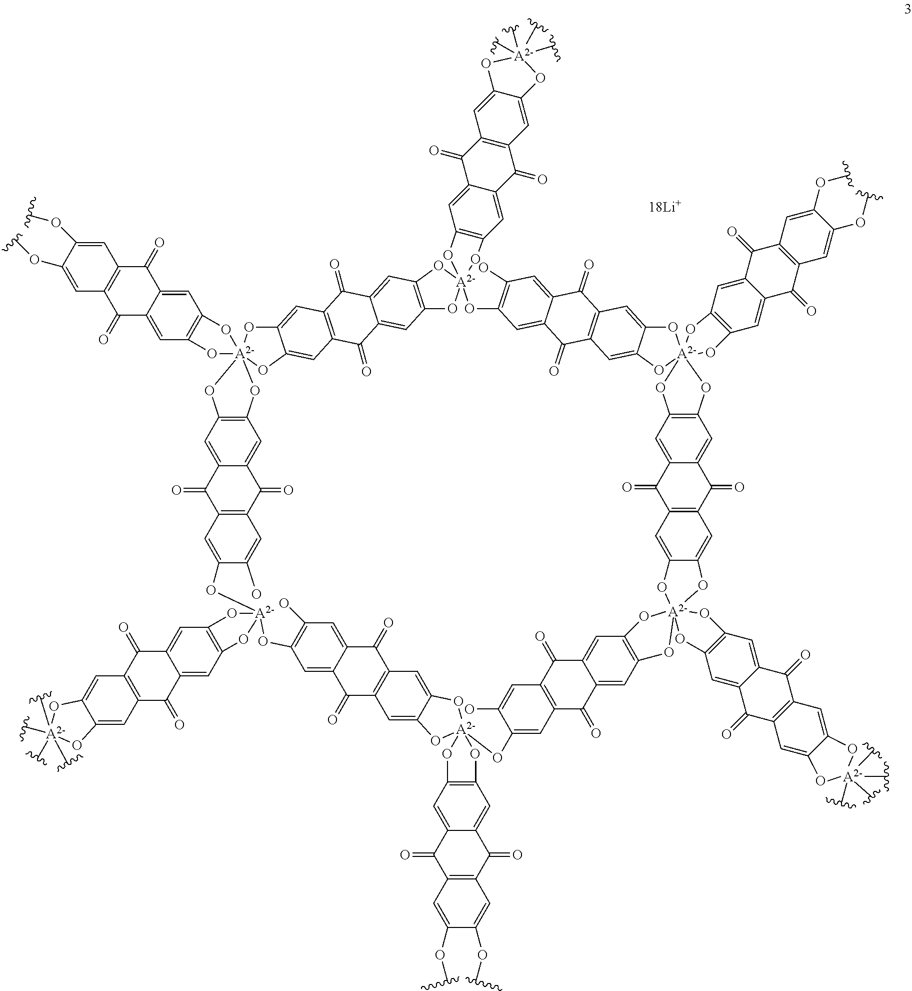

or a reduced form thereof, wherein A is Si or Ge

In certain embodiments, A is Si.

In a second aspect, provided herein is a method of preparing the AQ-COF described herein, wherein the method comprises: contacting AO₂, wherein A is Si or Ge; a compound of Formula 4:

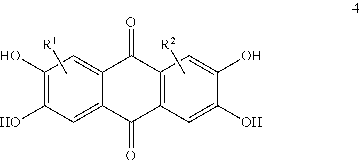

or a conjugate salt thereof, wherein each of R¹ and R² is independently hydrogen, C₁-C₃ alkyl, halide, nitro, or nitrile; and optionally a Brønsted base; thereby forming the AQ-COF.

In certain embodiments, the Brønsted base is a lithium C₁-C₃ alkoxide.

In certain embodiments, the step of contacting AO₂, the compound of Formula 4, and optionally a Brønsted base is conducted in an alcoholic solvent.

In certain embodiments, A is Si, each of R¹ and R² is hydrogen, the Brønsted base is LiOMe, and the alcoholic solvent comprises methanol.

In a third aspect, provided herein is a solid electrolyte interphase comprising the AQ-COF described herein, a lithium salt, and a non-aqueous liquid electrolyte solvent.

In certain embodiments, the lithium salt comprises LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, or a mixture thereof.

In certain embodiments, the non-aqueous liquid electrolyte solvent comprises ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, gamma butyrolactone, gamma valerolactone, 1,2-dimethoxyethane, tetrahydrofuran, 2-methyltetrahydrofuran, 1,3-dioxolane, dioxane, or a mixture thereof.

In certain embodiments, A is Si and each of R¹ and R² is hydrogen.

In certain embodiments, the lithium salt comprises LiPF₆ or LiClO₄ and the non-aqueous liquid electrolyte solvent comprises ethylene carbonate (EC) and diethyl carbonate (DEC).

In a fourth aspect, provided herein is an electrochemical device comprising: the solid electrolyte interphase described herein, a positive electrode, and a negative electrode, wherein the solid electrolyte interphase is disposed between the positive electrode and the negative electrode.

In certain embodiments, A is Si and each of R¹ and R² is hydrogen.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 depicts the development of the highly Li⁺ engaging AQ-Si-COFs. (A) Schematic illustration of solely focusing on making either redox-active COFs or anionic COFs, and this work is the first demonstration of the redox and anionic COFs (AQ-Si-COFs). (B) Synthesis of AQ-Si-COFs using reversible Si—O chemistry. (C) Schematic illustrations of Li⁺ transport in the AQ-Si-COFs. (D) Structural evolution during charge/discharge. (E) Redox mechanism of AQ-Si-COFs. (F) Cyclic voltammograms of AQ-Si-COFs in solution (1.5 M LiOH in deionized water).

FIG. 2 depicts the characterization of the AQ-Si-COFs: a-d, Structural features and e-h, Electrochemical transports. (A) Experimental, Rietveld refined, and simulated XRD patterns of AQ-Si-COFs. (B) FT-IR spectrum of the AQ-Si-COFs, THAQ, and silica gel, showing successful condensation of the reactants. (C) Solid-state ¹³C NMR spectrum of AQ-Si-COFs showing the structural integrity of the framework. (D) SEM image of AQ-Si-COFs showing the formation of uniform platelets. (E) Nyquist plots of AQ-Si-COF at various temperatures. (F) Li⁺ conductivities (σ) of AQ-Si-COF at various temperatures, the corresponding sloping lines are fitted using the Arrhenius equation with R₂>0.99. (G) Lithium transference number of AQ-Si-COF was calculated using the Bruce-Vincent-Evans technique. (H) Comparison chart of conductivity and t_{Li}_{⁺} for our samples and state-of-the-art values from the recent literature.

FIG. 3 depicts the battery cell performance: a-d, Capacity of the AQ-Si-COFs layer and e-j, Performance of the full cells using the AQ-Si-COFs layers. (A) Voltage profiles for AQ-Si-COFs|Li at the current density of 300 mAh g⁻¹.(B) Cycle performance for AQ-Si-COFs|Li at the current density of 300 mAh g⁻¹. (C) Voltage profiles for DMA-Si-COFs|Li at the current density of 100 mAh g⁻¹. (D) Comparison of rate performance of Si-COFs|Li cells at a current of 100, 200, 300, 400, and 500 mA g⁻¹. (E-G), Voltage profiles of LiCoO₂|AQ-Si-COFs/Li, LiCoO₂|DMA-Si-COFs/Li, and LiCoO₂|Li upon charge/discharge at 0.25 C, respectively. (H) Long-term cycling stability at 0.25 C. (I) Galvanostatic cycling of Li symmetric cells at the current density of 0.015 mA cm⁻². (J) Cross-sectional SEM image of Li anode of the cells with and without the AQ-Si-COFs coating as an SEI after 100 cycles.

FIG. 4 depicts 400 MHz ¹H NMR spectrum of 9,10-dimethyl-2,3,6,7-tetramethoxyanthracene (1) in CDCl₃.

FIG. 5 depicts 400 MHz ¹H NMR spectrum of 9,10-dimethyl-2,3,6,7-tetrahydroxyanthracene (2) in DMSO.

FIG. 6 depicts 400 MHz ¹H NMR spectrum of 2,3,6,7-Tetramethoxy-9,10-anthraquinone (3) in CDCl₃.

FIG. 7 depicts 400 MHz ¹H NMR spectrum of 2,3,6,7-Tetrahydroxy-9,10-anthraquinone (4) in DMSO.

FIG. 8 depicts experimental, simulated and Rietveld refined XRD patterns of Si-DMA-COFs.

FIG. 9 depicts FT-IR spectrum of DMA, Silica gel, and DMA-Si-COFs.

FIG. 10 depicts solid-state ¹³C NMR spectrum of DMA-Si-COFs (101 MHz).

FIG. 11 depicts SEM image of DMA-Si-COFs showing the formation of uniform platelets.

FIG. 12 depicts XPS analysis of (A) total elements (B) Si 2p and (C) Li 1s species on AQ-Si-COFs.

FIG. 13 depicts XPS analysis of (A) total elements (B) Si 2p and (C) Li 1s species on DMA-Si-COFs.

FIG. 14 depicts Nyquist plots of LE@DMA-Si-COFs at various temperatures. (LE: 1.0 M LiClO₄ in EC/DEC=50/50 (v/v)).

FIG. 15 depicts Arrhenius plot for ionic conductivities (σ) of DMA-Si-COFs at various temperatures, the corresponding sloping lines are fitted results of Arrhenius equation with R²>0.99.

FIG. 16 depicts lithium transference number of DMA-Si-COFs calculated using the Bruce-Vincent-Evans technique

FIG. 17 depicts CV curves of DMA-Si-COF at 0.004 and 0.005 V/s. (Inset shows a smaller range of CV curves at 0.003, 0.004, and 0.005 V/s).

FIG. 18 depicts CV curves of monomer THAQ at multiple scan rates from 0.001 to 0.005 V/s.

FIG. 19 depicts chemical structure of AQ-Si-COFs.

FIG. 20 depicts chemical structure of DMA-Si-COFs.

FIG. 21 depicts galvanostatic charge-discharge response for AQ-Si-COFs on the aluminum foil substrate.

FIG. 22 depicts galvanostatic charge-discharge response for stainless steel mesh substrate.

FIG. 23 depicts voltage profiles for AQ-Si-COFs|Li at the current density of 400 mAh g⁻¹. (AQ-Si-COFs|Li: the AQ-Si-COFs as cathode; Li metal as the anode; 1 m LiPF₆ in EC/DEC as an electrolyte).

FIG. 24 depicts cycle performance for DMA-Si-COFs|Li at the current density of 100 mAh g⁻¹ (DMA-Si-COFs|Li: the DMA-Si-COFs as cathode; Li metal as the anode; 1 m LiPF₆ in EC/DEC as an electrolyte).

FIG. 25 depicts comparison of rate performance at 0.25, 1, 2, 4, 6, and 8 C.

FIG. 26 depicts cycle performance for LiCoO₂|15 μm-AQ-Si-COFs/Li at 0.25 C.

FIG. 27 depicts the SEM images of the Li anode of the cells without (A-B) and with (C-D) the 15 μm AQ-Si-COFs coating as an SEI after 100 cycles.

FIG. 28 depicts the SEM images of the Li anode of the cells with different thickness of the AQ-Si-COFs coating as an SEI after 100 cycles. (A) The cross and (B) surface-section of 35 μm SEI sample. (C) The cross and (D) surface-section of 100 μm SEI sample.

### DETAILED DESCRIPTION

### Definitions

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

The present disclosure provides an anthraquinone-based covalent organic framework (AQ-COF) comprising a first repeating unit and a second repeating unit, wherein the first repeating unit comprises a moiety of Formula 1:

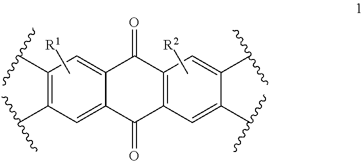

or a reduced form thereof, wherein each of R¹ and R² is independently hydrogen, C₁-C₃ alkyl, halide, nitro, or nitrile; and the second repeating unit comprises a moiety for Formula 2:

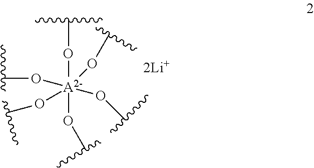

or a reduced form thereof, wherein A is Si or Ge.

In certain embodiments, the the reduced form of the moiety of Formula 1 further comprises one electron and one Li⁺ or two electrons and two Li⁺. The reduced form of the moiety of Formula 1 can be represented by a moiety selected from the group consisting of:

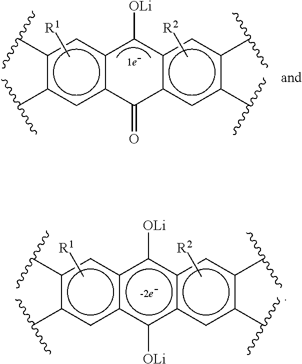

In certain embodiments, the the reduced form of the moiety of Formula 2 further comprises one electron and one Li⁺, two electrons and two Li⁺, or three electrons and three Li⁺. The reduced form of the moiety of Formula 2 can be represented by a moiety selected from the group consisting of:

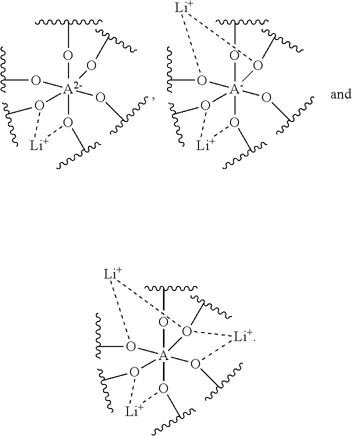

The first repeating unit and the second repeating unit are present in the AQ-COF in a ratio of about 1 to about 2.

In certain embodiments, each of R¹ and R² is independently hydrogen, fluoride, chloride, nitro, or nitrile. In certain embodiments, each of R¹ and R² is independently hydrogen or fluoride.

In certain embodiments, the AQ-COF comprises a repeating unit of Formula 3:

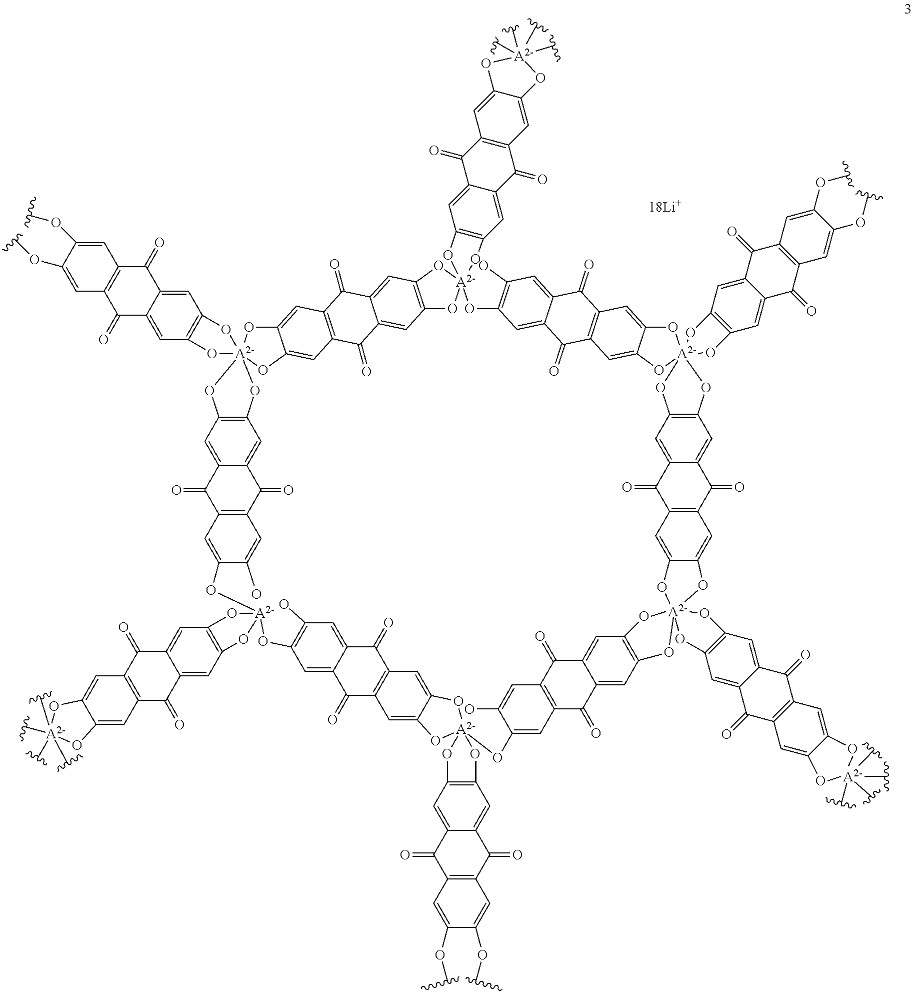

or a reduced form thereof, wherein A is Si or Ge.

The present disclosure also provides a method of preparing the AQ-COF described herein, the method comprising: contacting AO₂, wherein A is Si or Ge; a compound of Formula 4:

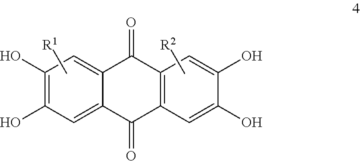

or a conjugate salt thereof, wherein each of R¹ and R² is independently hydrogen, C₁-C₃ alkyl, halide, nitro, or nitrile; and optionally a Brønsted base; thereby forming the AQ-COF.

The Brønsted base is not particularly limited and any Brønsted base that can catalyze the condensation of the AO₂ with the compound of Formula 4 can be used. The selection of the appropriate Brønsted base is within the skill of a person of ordinary skill in the art. Exemplary Brønsted bases include, but are not limited to metal hydroxides, metal carbonates, metal alkoxides, and the like, wherein the metal is lithium. In certain embodiments, Brønsted base is LiOH, LiOMe, LiOEt, LiOn-Pr LiOi-Pr, LiOt-Bu, Li₂CO₃, or mixtures thereof.

The reaction of AO₂ with the compound of Formula 4, and optionally the Brønsted base can be conducted in an alcoholic solvent, such as methanol, ethanol, isopropanol, or a mixture thereof.

The reaction temperature of the condensation reaction of AO₂ with the compound of Formula 4, and optionally the Brønsted base can depend on a number of factors, such as reagent concentration, structure of the starting materials, choice of Brønsted base, and selected solvent. The selection of the appropriate reaction temperature is well within the skill of a person of ordinary skill in the art. In certain embodiments, the reaction of AO₂ with the compound of Formula 4, and optionally the Brønsted base between 100° C. to 250° C., 150° C. to 250° C., 150° C. to 200° C., 160° C. to 200° C., 170° C. to 200° C., or 170° C. to 190° C. In certain embodiments, the reaction temperature is about 180° C. In certain embodiments the reaction of the AO₂ with the compound of Formula 4, and optionally the Brønsted base is conducted under autogenic pressure in a sealed reaction vessel.

The present disclosure also provides a solid electrolyte interphase comprising the AQ-COF described herein, a lithium salt, and a non-aqueous liquid electrolyte solvent.

The non-aqueous liquid electrolyte solvent can comprise propylene carbonate, ethylene carbonate, butylene carbonate, dimethyl carbonate (DMC), diethyl carbonate, methyl ethyl carbonate (MEC), fluoroethylene carbonate (FEC), γ-butyrolactone, methyl formate, methyl acetate, 1,2-dimethoxyethane, tetrahydrofuran, 2-methyltetrahydrofuran, dimethyl sulfoxide, 1,3-dioxolane, formamide, dimethylformamide, dioxane, acetonitrile, nitrom ethane, ethyl monoglyme, phosphoric triesters, trimethoxymethane, dioxolane derivatives, sulfolane, 3-methyl-2-oxazolidinone, propylene carbonate derivatives, tetrahydrofuran derivatives, ethyl ether, 1,3-propanesultone, N-methyl acetamide, acetonitrile, acetals, ketals, sulfones, sulfolanes, aliphatic ethers, cyclic ethers, glymes, polyethers, phosphate esters, siloxanes, dioxolanes, and N-alkylpyrrolidones. In certain embodiments, the non-aqueous liquid electrolyte solvent comprises EC, DMC, DEC, EMC, FEC, or mixtures thereof. In certain embodiments, the non-aqueous liquid electrolyte solvent comprises EC, DEC, or mixtures thereof.

The lithium salt can be any lithium salt that is in common use for lithium batteries, for example, any lithium salt that is soluble in the above-mentioned non-aqueous electrolytes. For example, the lithium salt may be at least one of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic carboxylic acid lithium, lithium tetraphenyl borate, LiNO₃, lithium bisoxalatoborate, lithium oxalyldifluoroborate, and lithium bis(trifluoromethanesulfonyl)imide. In certain embodiments, the lithium salt is LiPF₆ or LiClO₄.

Exemplary electrolytes include, but are not limited to, LiPF₆ in EC:DMC=1:1 Wt %; EC:DEC:EMC=1:1:1 Vol %; EC:DEC=1:1 Vol % with 5.0% FEC; EC:DMC:DEC=1:1:1 Vol %; EC:DMC:EMC=1:1:1 Wt %; EC:DEC=1:1 Vol %; EC:DMC=1:1 Vol % with 5.0% FEC; EC:DEC=1:1 Wt %; EC:EMC=3:7 Vol %; EC:DMC:EMC=1:1:1 Vol %; and EC:DMC=1:1 Vol %.

Also provided is an electrochemical device comprising: the solid electrolyte interphase described herein, a positive electrode, and a negative electrode, wherein the solid electrolyte interphase is disposed between the positive electrode and the negative electrode.

The negative electrode can comprise any cathode active material known in the art including, but not limited to, lithium transition metal oxides. The lithium transition metal oxide can include elements in addition to lithium, one or more transition metals and oxygen or can consist of lithium, one or more transition metals and oxygen. In instances where the lithium transition metal oxide includes cobalt as a transition metal, the lithium transition metal oxide can include more than one transition metal. In some instances, the lithium transition metal oxide excludes cobalt. The transition metal in the lithium transition metal oxide can include or consist of one or more elements selected from the group consisting of Li, Al, Mg, Ti, B, Ga, Si, Mn, Zn, Mo, Nb, V, Ag, Ni, and Co. Suitable lithium transition metal oxides include, but are not limited to, LiₓVO_{y}, LiCoO₂, LiNiO₂, LiNi_{1-x′}Co_{y′}Me_{z′}O₂, LiMn_{0.5}Ni_{0.5}O₂, LiMn_{1/3}Co_{1/3}Ni_{1/3}O₂, LiFeO₂, Li_{z}M_{yy}O₄, wherein Me is one or more transition metals selected from Li, Al, Mg, Ti, B. Ga, Si, Mn, Zn, Mo, Nb, V, Ag and combinations thereof and M is one or more transition metals such as Mn, Ti, Ni, Co, Cu, Mg, Zn, V, and combinations thereof. In some instances, 0<x<1 before initial charge of the battery and/or 0<y<1 before initial charge of the battery and/or x′ is ≥0 before initial charge of the battery and/or 1-x′+y+z=1 and/or 0.8<Z<1.5 before initial charge of the battery and/or 1.5<yy<2.5 before initial charge of the battery.

Additional examples of cathode active materials LiCoO₂, LiNiO₂, LiNi₁₋ₓCoyMe_{z}O₂, LiMn_{0.5}Ni_{0.5}O₂, LiMn_{(1/3)}Co_{(1/3)}Ni_{(1/3)}O₂, and LiNiCo_{y′}Al_{z′}O₂.

The positive electrode can comprise any anode active material known in the art. In certain embodiments, the anode active material comprises a metal selected from Groups IA, IIA, IIIB and IVB of the Periodic Table of the Elements and compounds capable of forming intermetallic compounds and alloys with metals selected from Groups IA, IIA, IIIB and IVB of the Periodic Table of the Elements. Examples of these anode active materials include lithium, sodium, potassium and their alloys and compounds capable of forming intermetallic compounds and alloys with lithium, sodium, potassium. Examples of suitable alloys include, but are not limited to, Li—Si, Li—Al, Li—B, Li—Si—B. Examples of suitable intermetallic compounds include, but are not limited to, intermetallic compounds that include or consist of two or more components selected from the group consisting of Li, Ti, Cu, Sb, Mn, Al, Si, Pb, Sn, In, Bi, Ag, Ba, Ca, Hg, Pd, Pt, Te, Zn and La. Other examples of suitable intermetallic compounds include, but are not limited to, intermetallic compounds that comprise lithium metal and one or more components selected from the group consisting of Ti, Cu, Sb, Mn, Al, Si, Pb, Sn, In, Bi, Ag, Ba, Ca, Hg, Pd, Pt, Te, Zn, and La. Other suitable anode active materials include lithium titanium oxides such as Li₄Ti₅O₁₂, silica alloys, and mixtures of the above anode active materials. The anode active material may be a graphite-based material, such as natural graphite, artificial graphite, coke, and carbon fiber; a compound containing at least one element such as Al, Si, Sn, Ag, Bi, Mg, Zn, In, Ge, Pb, and Ti, which can alloy with lithium, sodium, or potassium; a composite composed of the compound containing at least one element which can alloy with lithium, sodium, or potassium, the graphite-based material, and carbon; or a lithium-containing nitride; and combinations thereof.

In certain embodiments, the anode active material comprises silicon nanoparticles, monocrystalline silicon nanoparticles, monocrystalline silicon nanoflakes, silicon powder, silicon oxide, silicon oxide nanoparticles, SiOₓ particles, wherein x is 0.1 to 1.9, silicon nanotubes, silicon nanowires, tin nanopowder, tin oxide nanopowder, and combinations thereof.

In certain embodiments, the negative electrode and/or the positive electrode further comprises a conducting additive. The conducting additivecan be a carbon conducting additive, a polymer conducting additive, a metal conducting additive, or a combination thereof. Suitable carbon conducting additive include, but are not limited to, natural graphite, artificial graphite, carbon fiber, carbon nanofibers, carbon black, acetylene black, Ketjen black, carbon nanotubes, graphene, graphene oxide, and combinations thereof. In certain embodiments, the conducting additive is a carbon conducting agent selected from the group consisting of carbon black nanopowder, carbon nanoparticles, double-walled carbon nanotubes, 3D graphene foam, graphene monolayer, graphene multilayer, graphene nanoplatelets, graphene oxide monolayer, graphene oxide paper, graphene oxide thin film, graphite nanofibers, graphite powder, graphite rods, and combinations thereof; a conducting polymer additive selected from the group consisting of polyacetylene, polypyrrole, polyparaphenylene vinylene, polyisothianaphthalene, polyparaphenylene sulphide, polyparaphenylene, and combinations thereof; or a conducting metal additive selected from the group consisting of copper, nickel, aluminum, silver, and the like.

The lithium battery can be of any type known in the art. Exemplary batteries include, but are not limited to, coin cell, cylindrical cell (including 18650 cells), pouch cell, and prismatic cell.

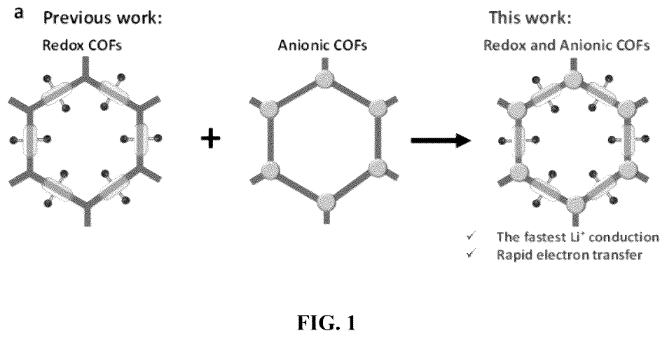

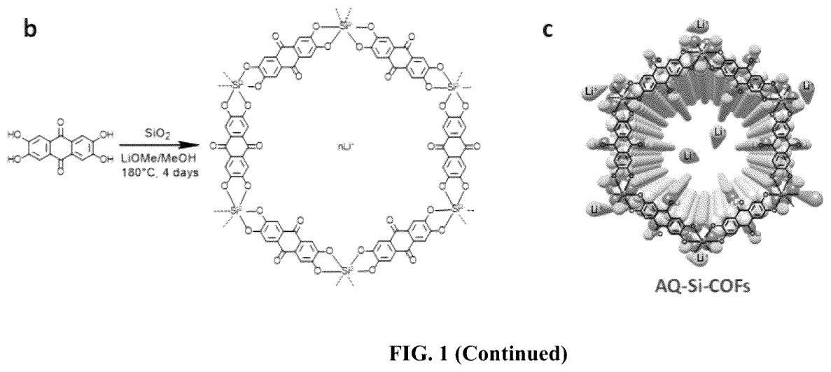

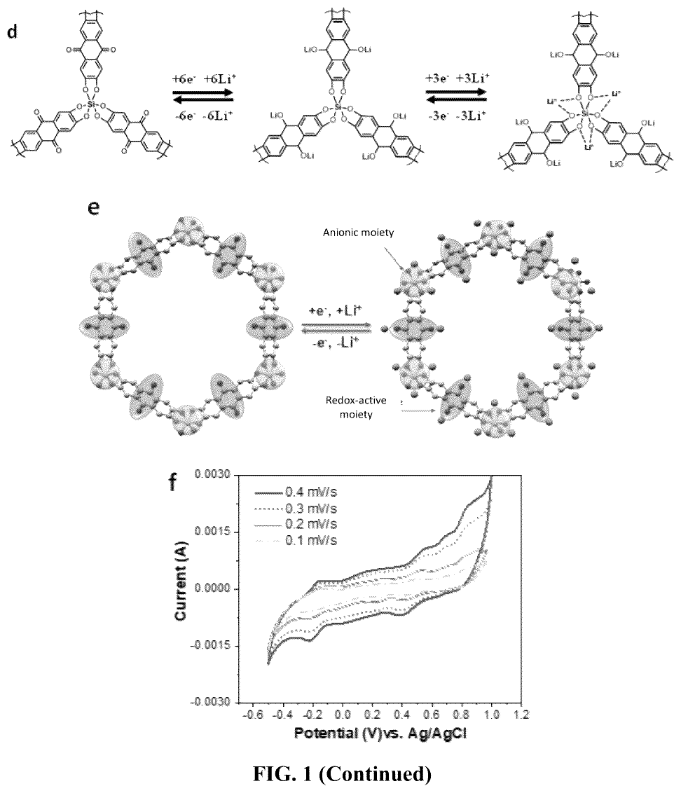

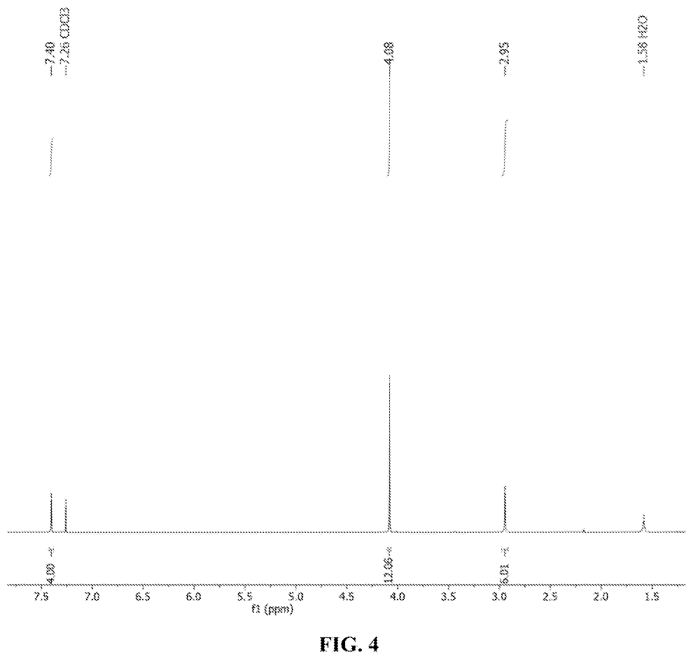

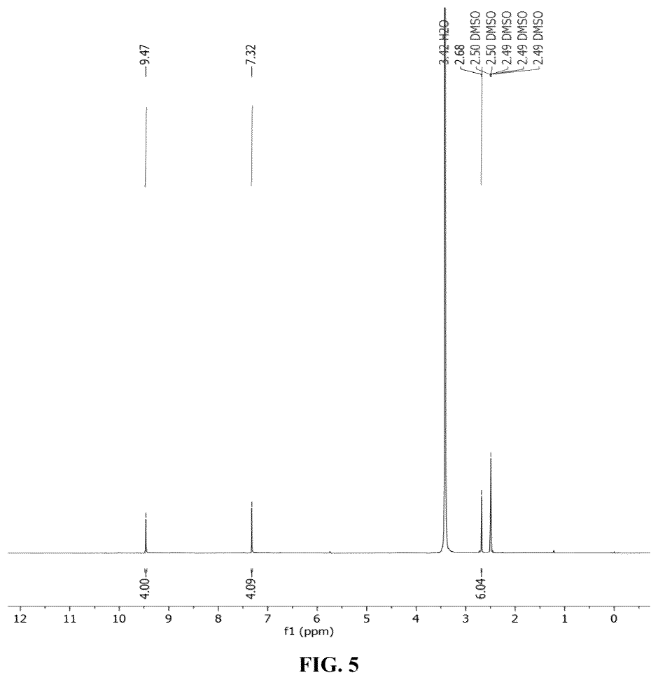

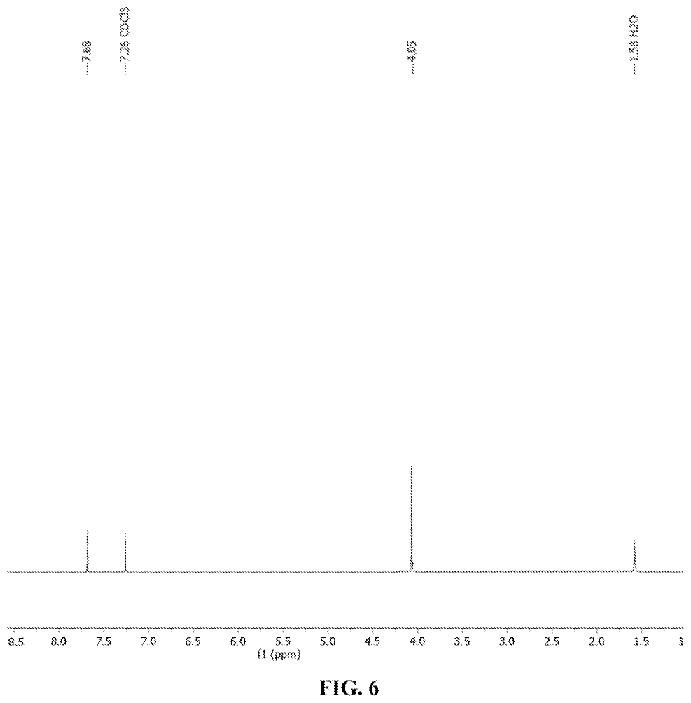

The synthesis of AQ-Si-COFs was carried out by condensation reaction between THAQ and SiO₂ in methanol, and lithium methoxide was added as Li⁺ source. The reaction mixture was heated at 180° C. for 4 days yielding dark brown powder, which was obtained in high yield (96%) (FIGS. 1b and 4-7). The synthesized AQ-Si-COFs were then deposited on a lithium metal anode to construct artificial solid electrolyte interphase. This beneficial SEI layer boosted the electrochemical performance and conductivity while inhibiting dendrite growth. During the charging process, each C═O unit is reduced into anionic C—O· by gaining one electron, which provide extra Li⁺ coordination sites, supplementing the original anionic hypervalent silicate nodes in the framework (FIGS. 1d and 1e). This leads to selective adsorption and storage of Li⁺ from the electrolyte upon charging, resulting in uniform Li⁺ flux throughout the COF channels. Moreover, electrochemical measurements verified that each unit of AQ-Si-COFs undergoes reversible 9e⁻ redox reaction and rapid electron transfer to the anode (FIG. 1f), contributing to the increased theoretical capacity and rate capability of the LiCoO₂|AQ-Si-COFs/Li compared with the LiCoO₂|DMA-Si-COFs/Li (DMA: 9,10-dimethyl-2,3,6, 7-tetrahydroxyanthracene; thus, DMA-Si-COFs, only having anionic groups, is a control sample to the AQ-Si-COFs) and LiCoO₂|Li (a control sample having no SEI).

Specifically, the AQ-Si-COFs should go through two steps of the redox processes for the 9e⁻ transfer reaction (FIG. 1f). Cyclic voltammograms (CVs), measured in 1.5 M LiOH supporting electrolyte, showed that the AQ-Si-COFs underwent reversible redox processes. The AQ-Si-COFs had three reduction peaks at −0.24V, 0.1V and 0.2V and three oxidation peaks at −0.20V, 0.14V and 0.28V. The two main peaks at −0.24 and −0.2 Vs correspond to the reversible redox reactions of the C═O groups in electrodes during the Li⁺ insertion/deinsertion process. The peaks near 0.1V, 0.2V, 0.14V and 0.28V are attributed to the electron transfer in the silicate parts. The redox reaction of dianionic SiO₆ involves two electrons, but the process is not totally reversible. Moreover, the peak intensity of C═O groups is much higher than the silicate part due to the high kinetics of enolization. These results indicate the embedded C═O groups in the AQ-Si-COFs provided extra Li⁺ coordination sites to achieve enhanced electrochemical performance. The peak separation (ΔEp) between the oxidative and reductive waves was small (40 mV), indicating rapid electron transfer between the base electrode and the quinone groups in the AQ-Si-COFs.

This mechanism resulted in the AQ-Si-COFs' highest Li⁺ conductivity of 9.8 mS cm⁻¹ at room temperature and single-ion conducting near-unity t_{Li}_{⁺} of 0.92 at the interphase. The battery cells using AQ-Si-COFs as SEI achieved a high reversible capacity of 206 mAh g⁻¹ at 0.25C (50 mA g⁻¹) and stable cyclabilities up to 100 cycles (only less than 40% decreased). More importantly, the symmetric cell with AQ-Si-COFs coating showed very stable Li plating/stripping for over 1000 h without considerable changes or irreversible fluctuation of overpotential. One important quality that a SEI needs is high mechanical strength to suppress dendrite growth and minimize electrode volume expansion and contraction during repeated cycling. In this sense, COFs from all covalent bonds with the highest modulus value among SEI materials, is the ideal candidate. Overall, the COFs bearing redox-active moieties and anionic groups provide an exciting pathway to improve the battery performance with sustained electrochemical performance.

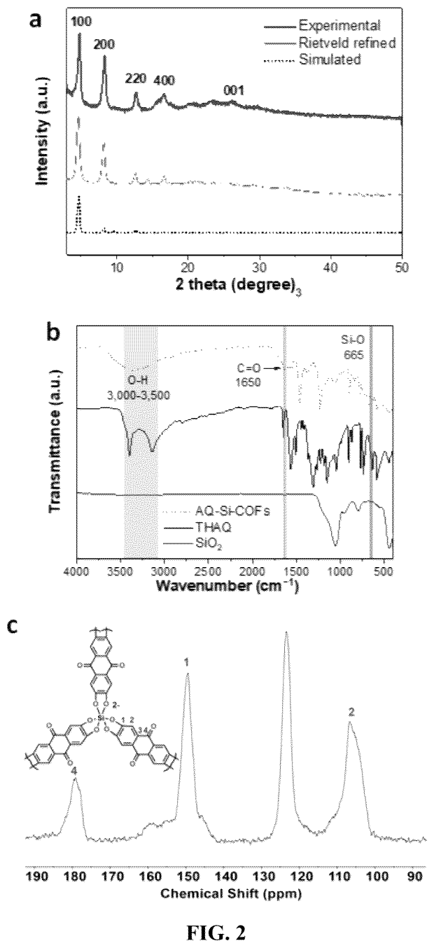

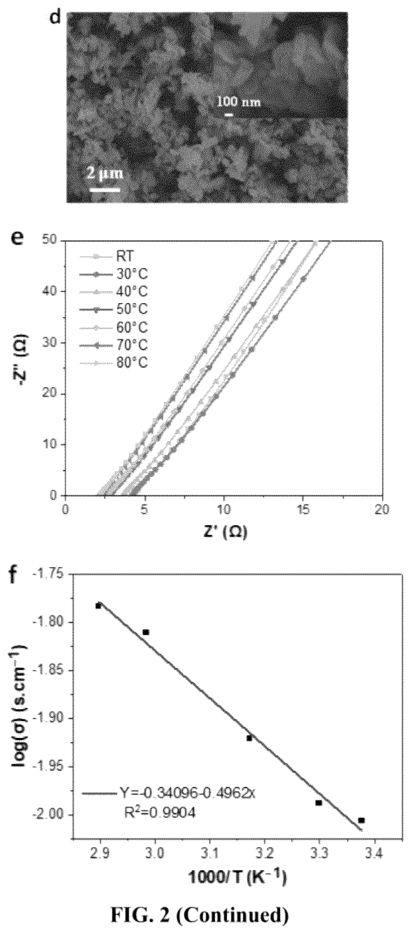

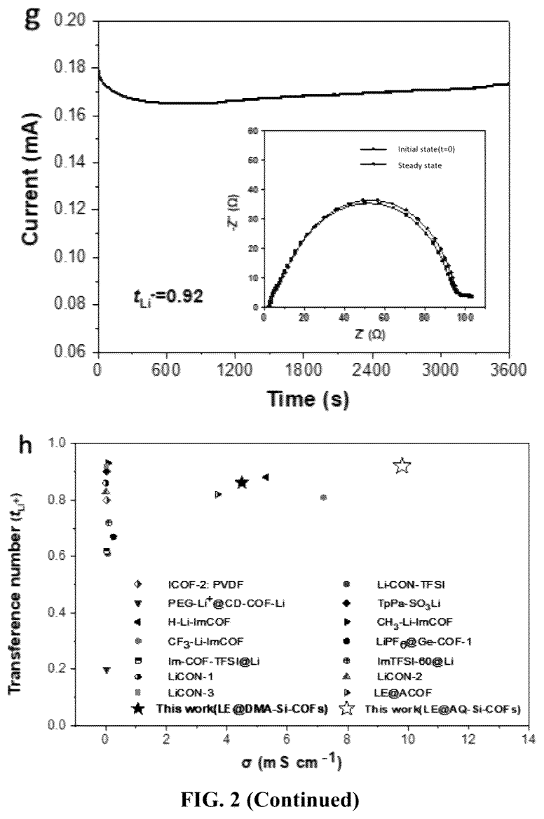

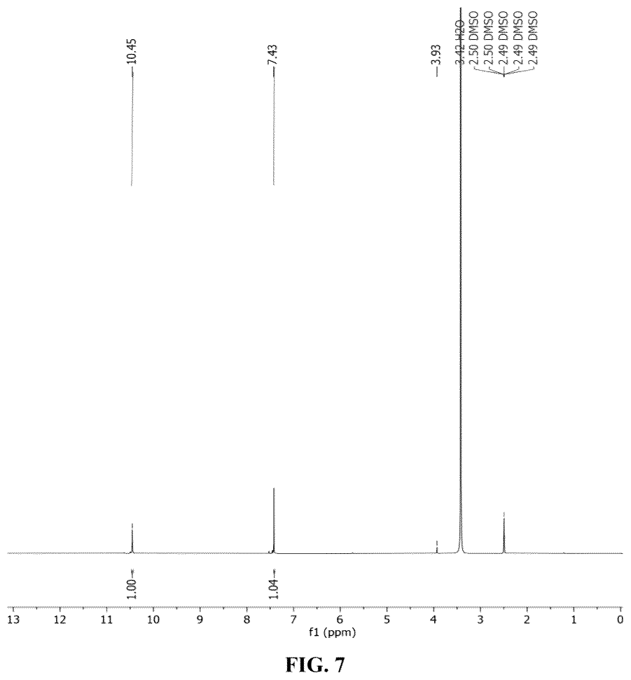

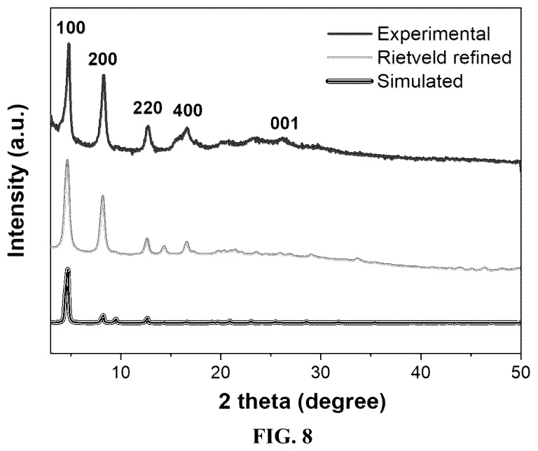

Next, the synthesized AQ-Si-COFs were comprehensively characterized. The crystallinity of the frameworks was determined by powder X-ray diffraction (PXRD). Sharp diffraction peaks at 4.8° and 8.3° confirmed the layered crystalline nature of the synthesized 2D COF networks (FIG. 2a), similar to the previously published study (FIG. 8). It appears that the quinone group did not affect the formation of the 2D layered COFs, indicating that defect-free AQ-Si-COFs were formed successfully by the solvothermal synthesis; otherwise, additional or broadened peaks for the pentacoordinate silicon or other structure should have appeared.

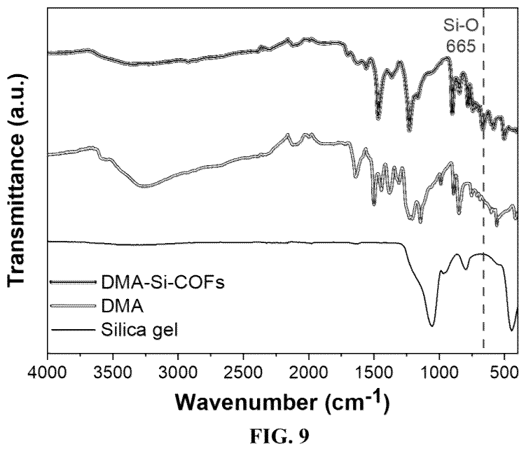

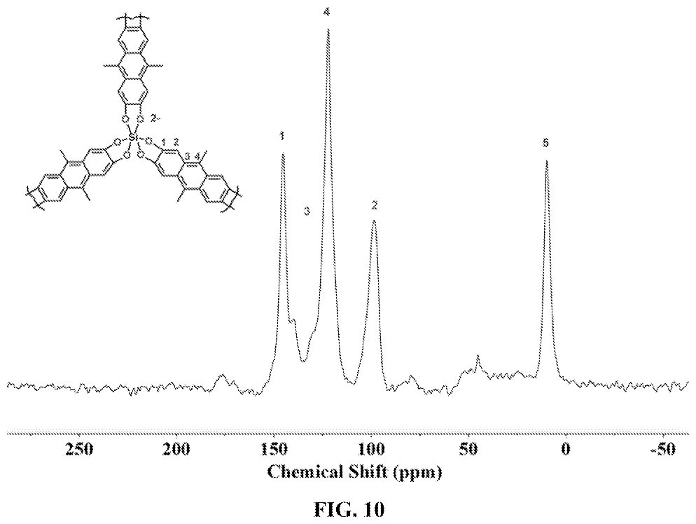

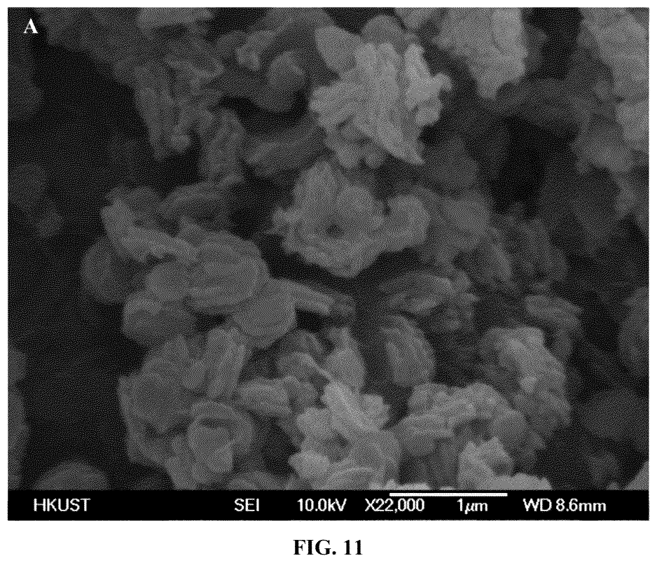

The completion of the reaction and the structural integrity of the networks through the formation of octahedral silicate anions were assessed by Fourier-transform infrared (FTIR) spectroscopy and solid-state NMR (ssNMR) (FIG. 2b,c). FTIR spectra of the THAQ monomer strongly contained O—H stretching bands (3,200-3,600 cm⁻¹), while the spectra of th AQ-Si-COFs contained the strongly attenuated O—H stretching bands, indicative of successful condensation of the reacting monomers (FIG. 2b). Moreover, a new band at 665 cm⁻¹ appeared in the spectrum of the COFs, attributed to the Si—O stretching mode in a hexacoordinate silicate compound (FIG. 9). The C═O stretching bands was observed at 1,650 cm⁻¹ for both the COFs and THAQ, showing that the carbonyl groups in the AQ-Si-COFs are existing. To clearly confirm the structural integrity of the network, we used the ssNMR to test the samples of the AQ-Si-COFs and DMA-Si-COFs (FIGS. 2c and 11). For AQ-Si-COFs, the characteristic peak, labeled as peak 4, at ca. 180 ppm indicates the existence of the carbonyl carbon (FIG. 2c). The peaks at 150 (Peak 1), 122 (Peak 3), and 105 (Peak 2) ppm are for the carbons of the benzene rings. The spectrum reflects all expected peaks, indicating the structural integrity of AQ-Si-COFs. Furthermore, the DMA-Si-COFs were also successfully synthesized. The ssNMR spectrum exhibited all the typical peaks, giving further evidence of the formation of the Si-COFs (FIG. 10). The crystalline morphology of the AQ-Si-COFs was observed by scanning electron microscopy (SEM). The AQ-Si-COFs particles present aggregated flower cluster morphology formed by nanosheets with an approximate thickness of 15 nm (FIG. 2d). confirmed the crystallinity of the networks. For DMA-Si-COFs from silica gel, as imaged by SEM, the Si-COFs particles reveal spherical morphologies, which are composed of nanoplatelets with an approximate thickness of 18 nm (FIG. 11).

Furthermore, inductively coupled plasma atomic emission spectroscopy (ICP-OES) confirmed the formation of the DMA-Si-COFs with stoichiometric composition (Li₂[Si(C₁₆H₁₀O₄)_{1.5}]) and the theoretical chemical composition of Li₂[Si(C₁₄H₄O₆)_{1.5}] for AQ-Si-COFs and testified the formation of a negatively charged organic quinone based framework compensated with Li cations.

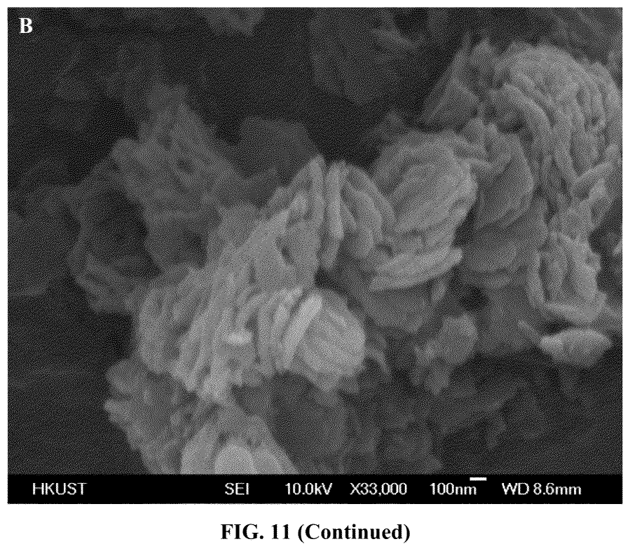

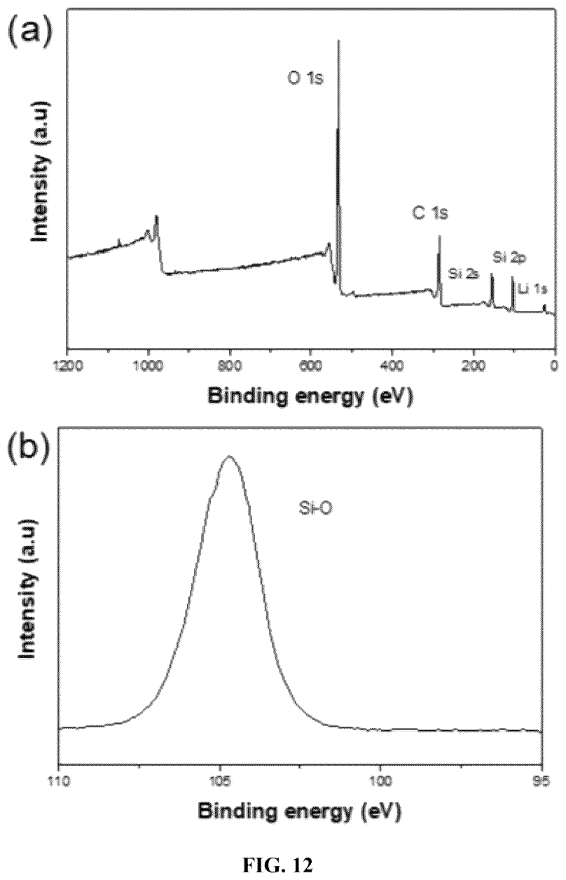

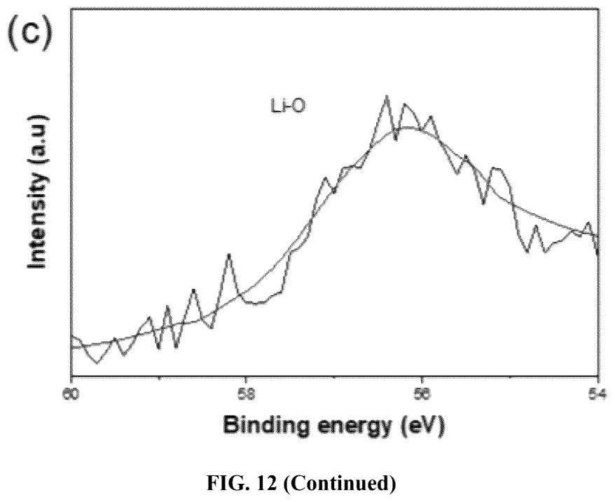

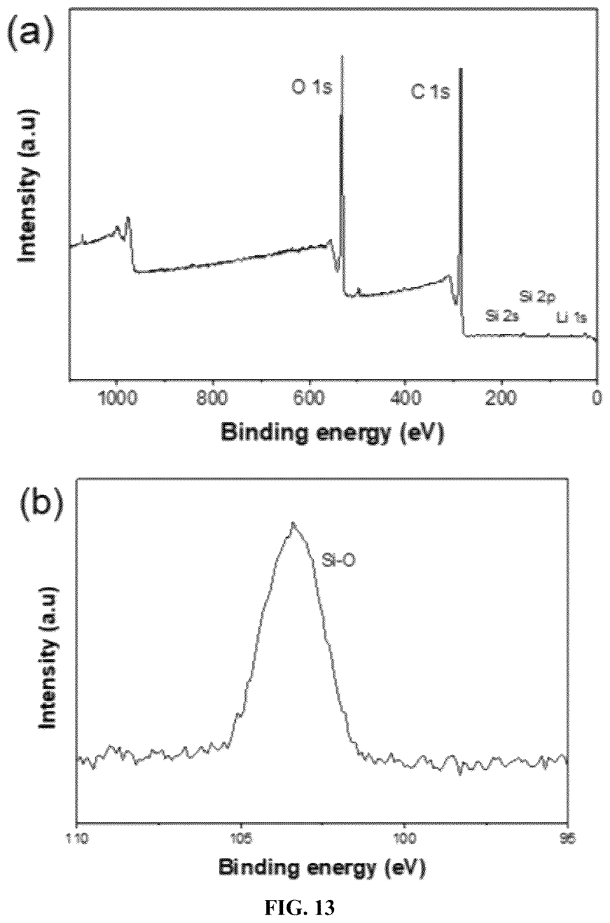

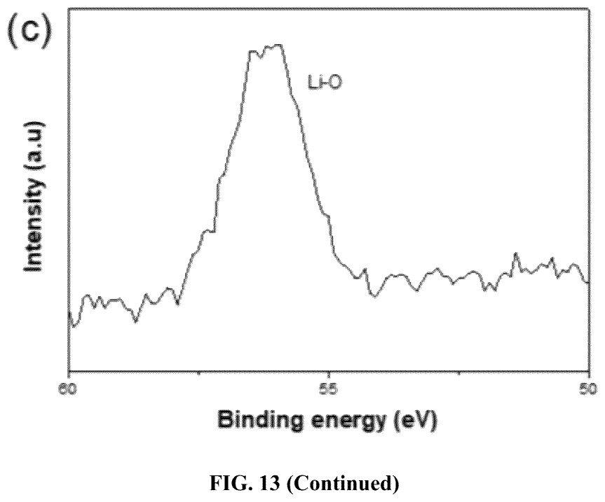

The X-ray photoelectron spectroscopy (XPS) of AQ-Si-COFs and DMA-Si-COFs were conducted for surface analysis (FIGS. 12, 13). Binding energy at 104.7 eV (FIGS. 12b) and 56.2 eV (FIG. 12c) are ascribable to Si 2p in Si—O and Li 1s in Li—O bonds, respectively. In addition, no Si—Li bond (<54.4 eV and 98-98.4 eV) was found, indicating the defect-free network formation of the AQ-Si-COFs. The survey scanning detects signals of Si 2p (103.4 eV), and Li 1s (56.1 eV) for DMA-Si-COFs are consistent with the previous reports.

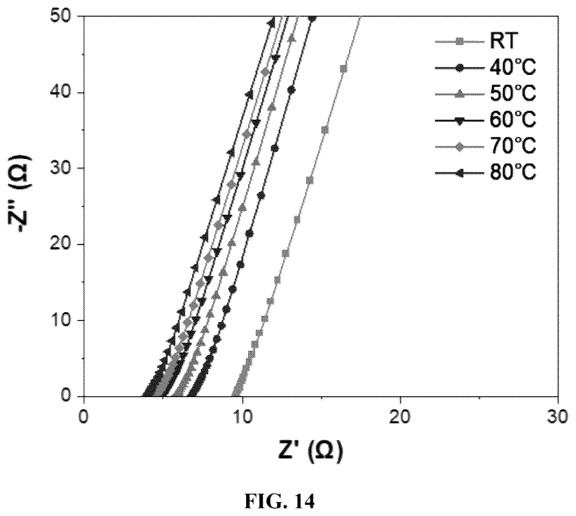

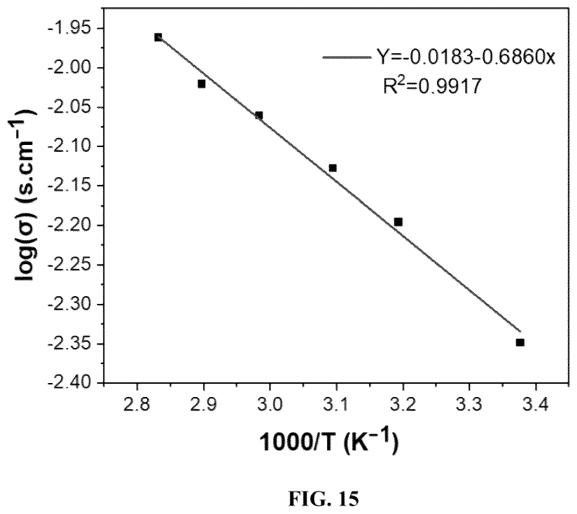

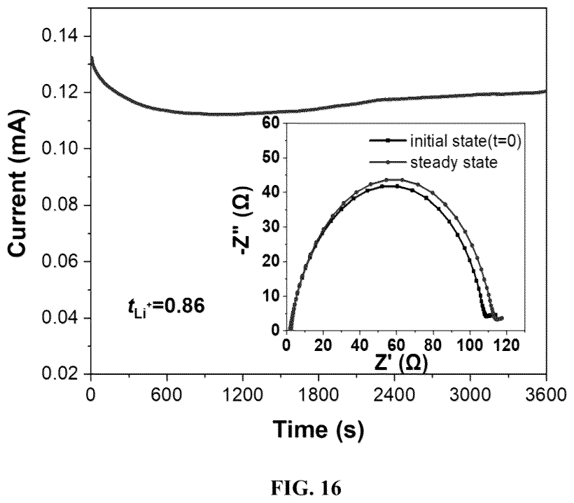

Upon the completion of the structural characterization, ionic conductivity (σ) of the samples was measured using electrochemical impedance spectroscopy (EIS). The measurement of ionic conductivity was carried out in a coin cell configuration, where the sample pellet was fixed between two stainless steel plates, at a frequency ranging from 1 to 10⁶ Hz with an amplitude of 100 mV. The conductivity of the AQ-Si-COFs pellets are calculated to be 9.8 mS cm⁻¹ at room temperature (FIG. 2e), yielding the thermal activation energy of 0.098 eV (FIG. 2f). The AQ-Si-COFs showed t_{Li}_{⁺} of 0.92, showing the single-ion conducting behavior (FIG. 2g). This conductivity and transference numbers are the highest among the state-of-the-art examples (FIG. 2h), demonstrating great potential for the electrolyte materials. For DMA-Si-COFs, conductivity was calculated to be 4.5 mS cm⁻¹ at room temperature, and the t_{Li}_{⁺} was 0.86 with an activation energy of 0.14 eV (FIG. 14-16). The higher values from the AQ-Si-COFs show that Li⁺ are preferentially adsorbed and stored in the redox and anionic sites during the charging.

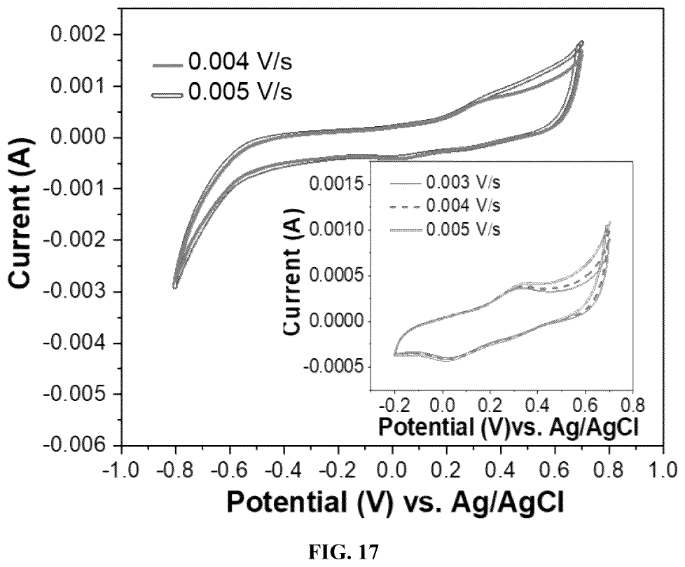

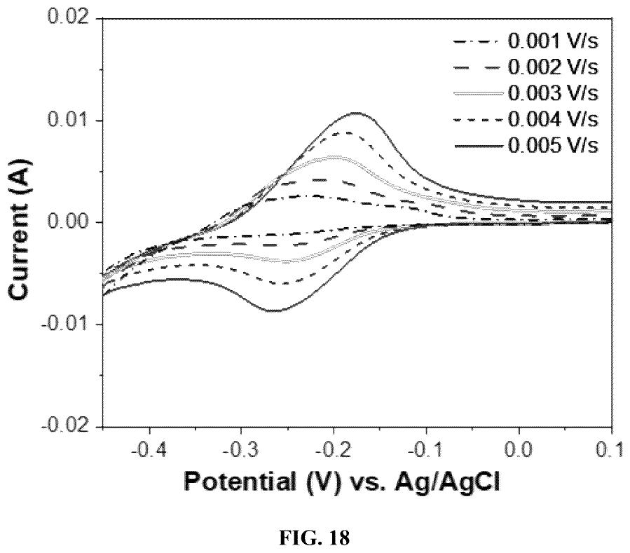

For cyclic voltammograms (CVs) of DMA-Si-COFs, only silicate redox peaks were found during the CV testing: one reduction peaks at 0.04 and one oxidation peak at 0.3V (FIG. 17). The porous and 2D layered architecture of the Si-COFs backbone provided rapid pathways for charge transport (FIG. 1f) while the corresponding redox activity of THAQ monomer exhibited a larger ΔEp≈100 mV due to a rather slow heterogeneous charge transfer process (FIG. 18). Furthermore, compared with the redox behavior of monomer THAQ, the peak current of AQ-Si-COFs shows no attenuated tendency at the same scan rate, which illustrates the reactive quinone groups in the COF architecture (FIG. 1f, FIG. 18).

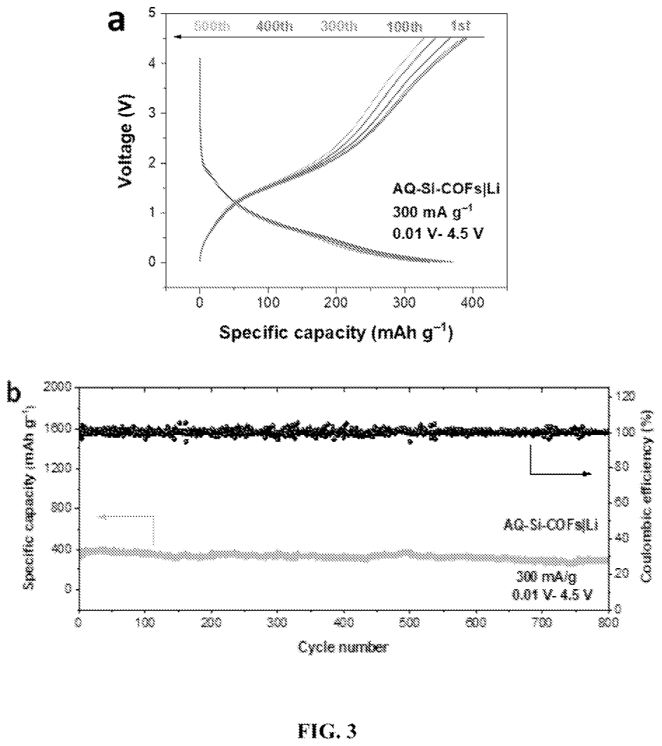

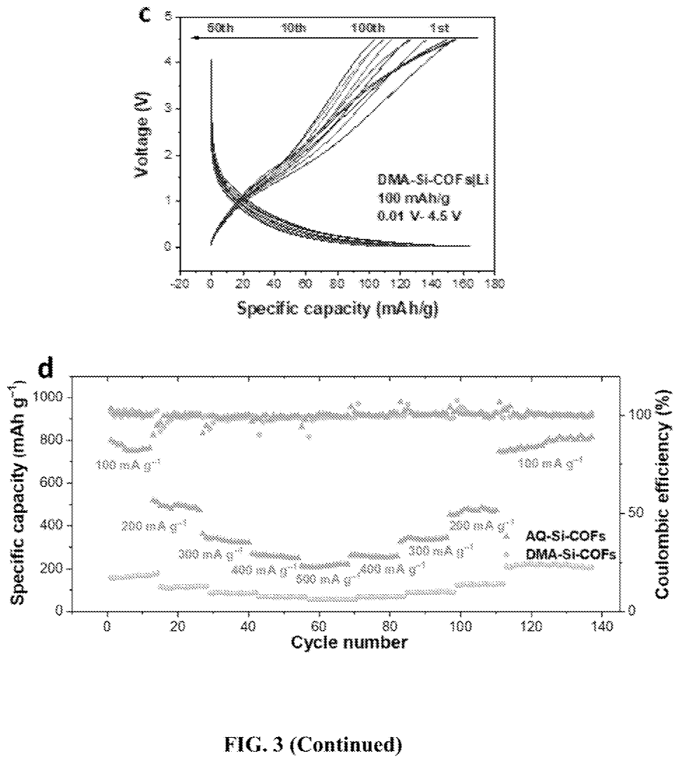

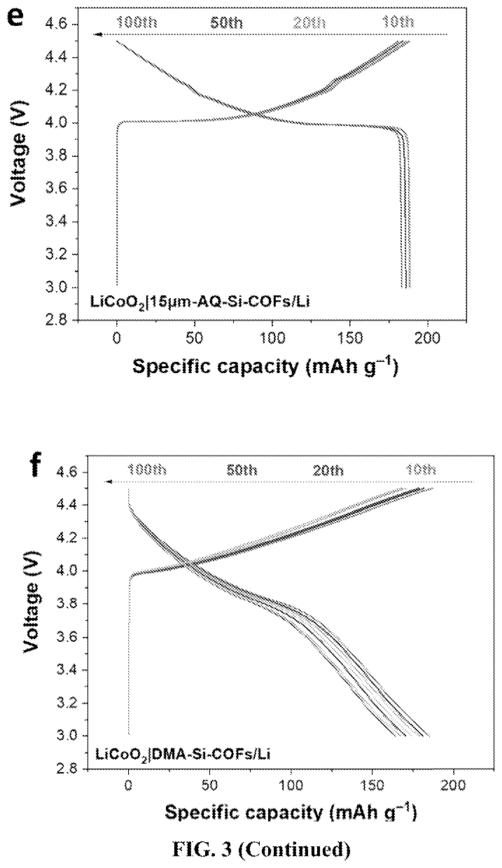

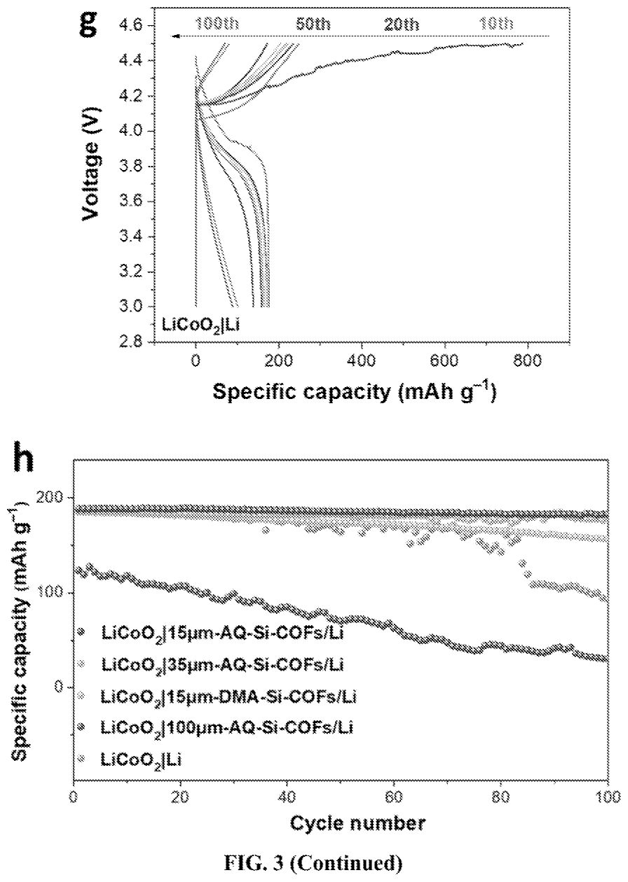

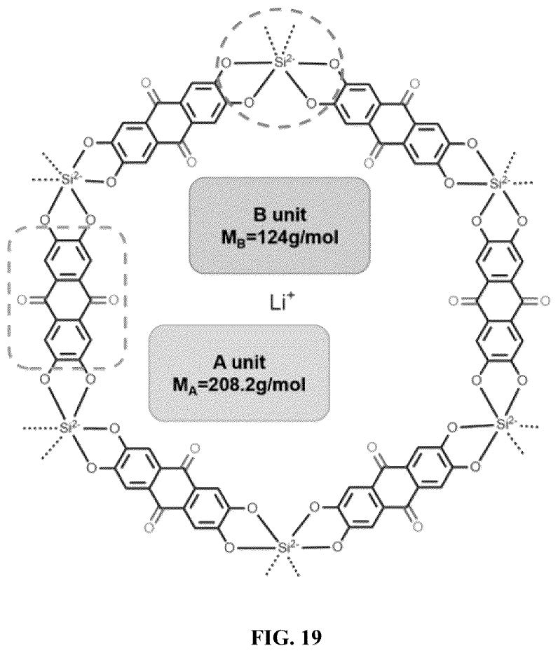

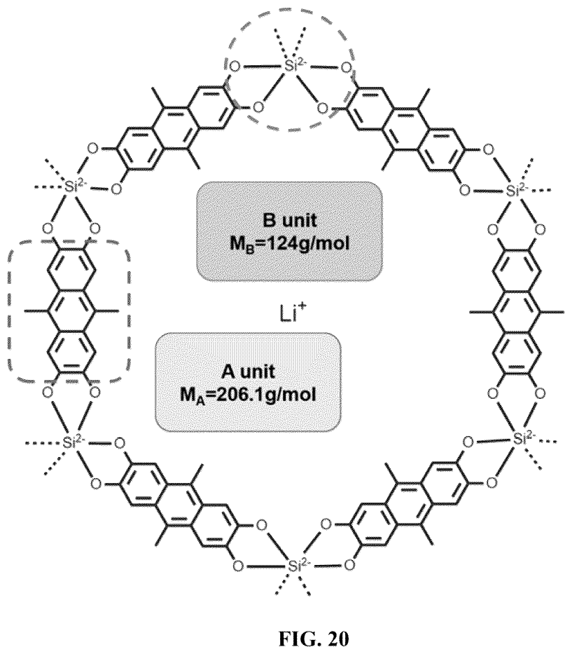

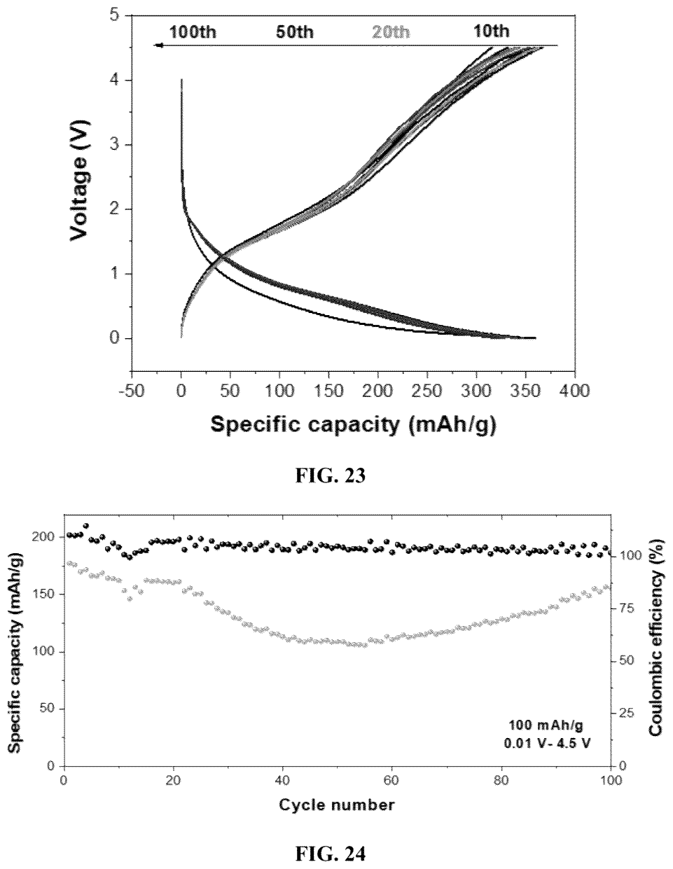

After the comprehensive materials characterization, we tested the capacity of the COF materials. The specific capacity of AQ-Si-COFs and DMA-Si-COFs were tested in a full coin cell setting (The Si-COFs as cathode; Li metal as the anode (Si-COFs|Li; 1 m LiPF₆ in EC/DEC as an electrolyte). The charge/discharge voltage (FIG. 3a) profiles for AQ-Si-COFs exhibited two main discharge plateaus around 2V, which is in good agreement with the main reduction peaks. The practical capacity reached 428 mAh g⁻¹ at the current density of 300 mAh g⁻¹, exceeding the theoretical value of 307.5 mAh g⁻¹ (FIG. 19), which is attributed to the porous physical structure with enhanced charge diffusion and storage. The AQ-Si-COFs also showed excellent durability showing increasing capacity, from 306 mAh g⁻¹ to 428 mAh g⁻¹ up to 100 cycles, measured at 300 mA g⁻¹ (FIG. 3b). Even at the current density of 400 mA g⁻¹, the cell still running stably up to 100 cycles (FIG. 23). Compared with AQ-Si-COFs, DMA-Si-COFs render the capacity of 178 mAh g⁻¹ (Theoretical capacity: 123.8 mAh g⁻¹ (FIG. 20)) even at a current of 100 mA g⁻¹ with the trend of decreasing first and then increasing to 156 mAh g⁻¹ during the 100 cycles (FIGS. 3c and 24). Notably, the capacities for AQ-Si-COFs are 800, 539, 362, 269, and 212 mAh g⁻¹ at a current of 100, 200, 300, 400, and 500 mA g⁻¹, respectively, more than four times higher than those of DMA-Si-COFs at the same current level, 157, 115, 85, 68, and 55 mAh g⁻¹. (FIG. 3d). Impressibly, the capacity of the Si-COFs recovered to the initial values when the current density went through a test cycle of increasing to 500 mA g⁻¹ and decreasing back to the initial 100 mA g⁻¹, demonstrating the Si-COFs possess excellent stability over the wide range of charge/discharge rates.

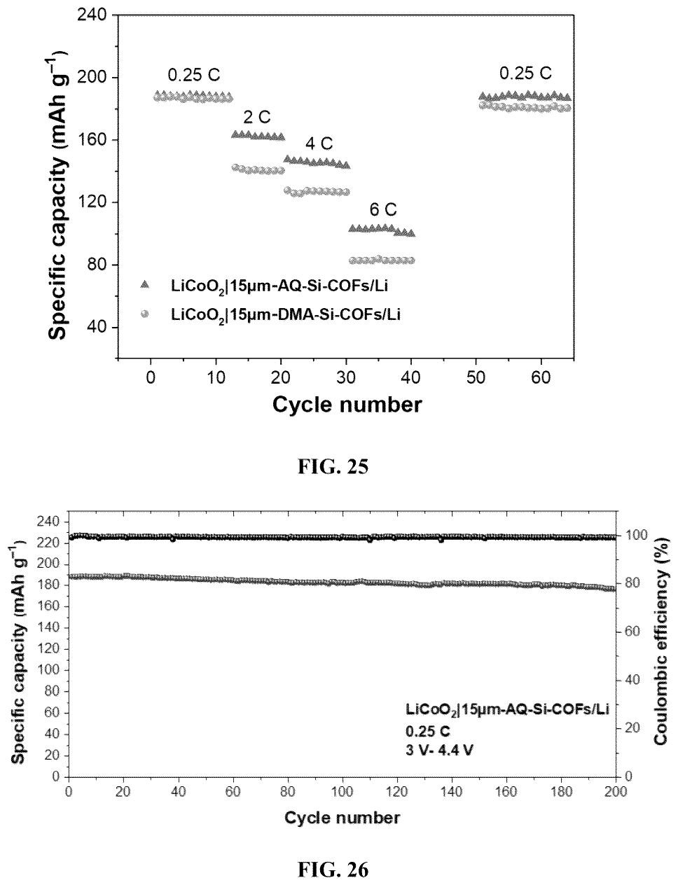

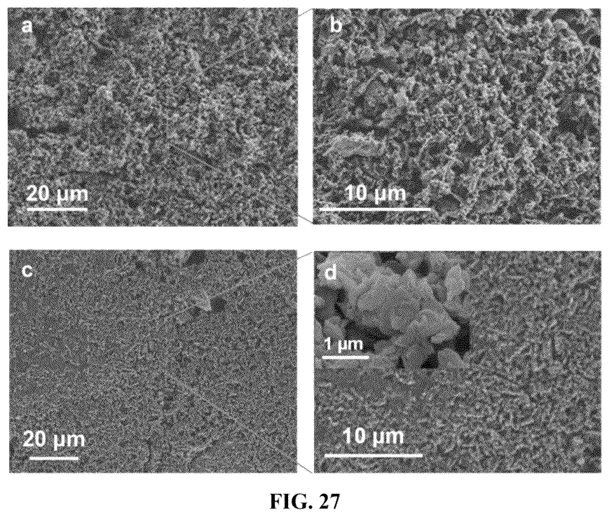

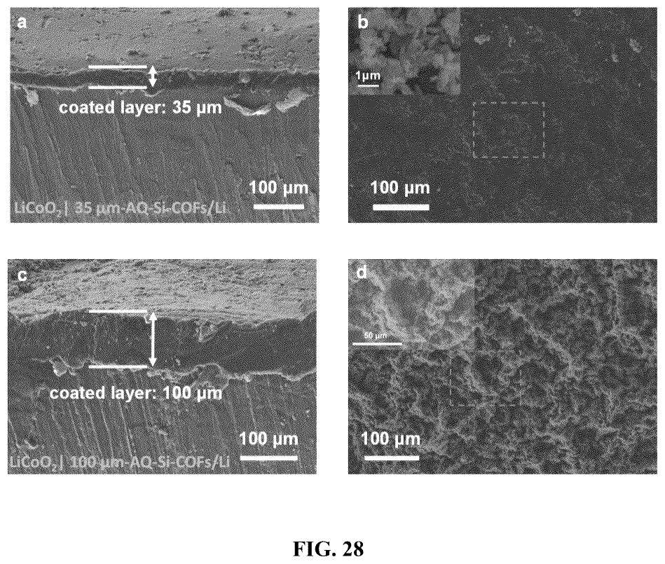

With the promising capacity data from the AQ-Si-COFs, the AQ-Si-COFs were used as an electrolyte interphase on a Li anode, with LiCoO₂ as cathode and 1.0 M LiPF₆ in EC/DEC=50/50 (v/v) as electrolyte. The voltage window for the full cell (labelled as LiCoO₂|AQ-Si-COFs/Li) was set from 3.0V to 4.5V (1 C=206 mAh g⁻¹). In comparison with the LiCoO₂|DMA-Si-COFs/Li and LiCoO₂|Li cells, the LiCoO₂|AQ-Si-COFs/Li cell displayed smaller voltage hysteresis between charge and discharge curves and the capacity reached 206 mAh g⁻¹ at 0.25C, exceeding those of LiCoO₂|DMA-Si-COFs/Li (185mAh g⁻¹) and LiCoO₂|Li (169mAh g⁻¹) (FIG. 3e-g). The galvanostatic charge/discharge performances of Si-COFs coated cell (LiCoO₂|AQ-Si-COFs/Li, LiCo021DMA-Si-COFs/Li) and bare Li cell (LiCoO₂|Li) were compared in FIG. 3h. The capacity of LiCoO₂|AQ-Si-COFs/Li maintained over 60% after 100 cycles at 0.25C, while the LiCoO₂|DMA-Si-COFs/Li retained only 36% of the initial value during the same cycles. However, the capacity of cell without Si-COFs coating displayed an unstable and declining tendency with a capacity retention of 46%. For the rate performance, different C rates (1 C=206 mAh g⁻¹), 0.2, 1, 2, 4, 6 and 8 C, were applied to the cells. The LiCoO₂|AQ-Si-COFs/Li showed a better rate capability, with the capacity reaching 99 mAh/g even at 4 C (FIG. 25).

To further investigate the effect of AQ-Si-COFs as the electrolyte interphase on dendrite suppression, galvanostatic plating-stripping Li symmetric cell was performed at a current density of cells at 0.015 mA cm⁻² for periodic 1 h. The cell with AQ-Si-COFs coating (AQ-Si-COFs/Li|AQ-Si-COFs/Li) showed a stable cycling performance with a small overpotential of 20 mV without significant overpotential fluctuation during 1000 h, indicating ultrastable Li plating/stripping behavior (FIG. 3i). This result is in accordance with the smaller voltage hysteresis of LiCoO₂|AQ-Si-COFs/Li (FIG. 3e). By contrast, the cell without Si-COFs coating displayed a substantially increasing overpotential from 14 mV at 0 h to more than 200 mV at 423 h. This test demonstrates a very low electrode polarization and excellent interfacial stability between the AQ-Si-COFs electrolyte interphase and the Li metal anode. Cross-sectional SEM images of the Li anode corroborate that the AQ-Si-COFs layer worked stably for the Li⁺ conduction while suppressing the dendrite growth (FIG. 3j). However, cycled Li metal without Si-COFs coating revealed a large density of dendrites.

2D COFs with redox and anionic sites in the unit cell are herein described. A large number of Li⁺conducting sites and synergistic effect between redox and anionic sites enabled the Li⁺ conductivity of 9.8 mS cm⁻¹, and single-ion conducting t_{Li}_{⁺} of 0.92, the record values compared with the state-of-the-art examples (FIG. 2h). Highly conductive and selective Li⁺ transporting layer contributed to the reversible capacity of 800 mAh g⁻¹ at the current density of 100 mA g⁻¹. The redox and anionic COFs were used as an SEI on the anode of the LMB. Coating the Li anode with AQ-Si-COFs as the electrolyte interphase enabled the cell to achieve an excellent capacity (206 mAh g⁻¹ at 50 mA g⁻¹) and stable cyclabilities while suppressing the dendrite formation. Thus, this development of redox-active silicate COFs shows a promising direction on how 2D COF materials can be used in electrochemical energy storage devices, opening a new window to improve the performance of Li metal batteries.

Chemicals and materials. 1,2-dimethoxybenzene (Energy Chemical, ACS reagent, 99%), acetaldehyde (Sigma-Aldrich, ACS reagent, ≥99.5%), sulfuric acid (Honeywell, ACS reagent, 95%-97%), 1.0 M BBr 3 solution in anhydrous dichloromethane (Energy Chemical, ACS reagent), lithium methoxide (Energy Chemical, ACS reagent, 98%), silica gel (for column chromatography, pore size 60 Å, 230-400 mesh ASTM, Merck/Millipore), sodium dichromate (Sigma-Aldrich, ACS reagent, ≥99.5%), glacial acetic acid (VWR, ACS reagent, 99.8-100.5%), HBr (Energy Chemical, ACS reagent, 48wt. % in H₂O), Chloroform-d (Sigma-Aldrich, 99.8 atom % D, contains 1% (v/v) TMS), Dimethyl Sulfoxide-d₆ (Sigma-Aldrich, 99.96 atom % D).

### Synthesis of Monomers

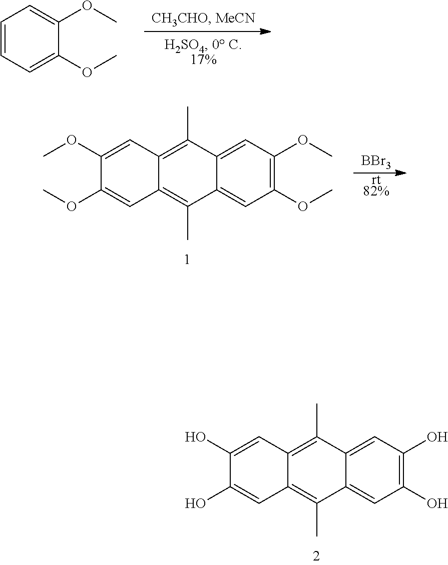

Synthetic route of 9,10-Dimethyl-2,3,6,7-tetrahydroxyanthracene (2).

9,10-Dimethyl-2,3,6,7-tetramethoxyanthracene (1). A mixture of 1,2-dimethoxybenzene (13.82 g, 0.1 mol), acetaldehyde (5.6 mL, 0.1 mol), and acetonitrile (5.2 mL, 0.1 mol) was cooled to 0° C. and added dropwise to 100 mL of concentrated sulfuric acid over 10 minutes. The purple reaction mixture was stirred at 0° C. for 2 h and then poured over ice. The formed precipitate was filtered, washed with deionized water, and recrystallized from acetone to give 1 as a grey solid (5.43 g, 17%). ¹H NMR (400 MHz, CDCl₃): δ=7.41 (s, 4H), 4.09 (s, 12H), 2.95 (s, 6H). ¹³C NMR (100 MHz, CDCl³): δ=148.83, 125.93, 124.02, 102.73, 55.82, 14.92. HRMS (ESI-TOF): m/z Calcd for C₂₀H₂₂O₄: [M]⁺ 326.1518, found 326.1516 [M+Na]⁺ 349.1416, found 349.1416.

9,10-Dimethyl-2,3,6,7-tetrahydroxyanthracene (2). To a flame dried round-bottomed flask equipped with a stir bar was added 9,10-dimethyl-2,3,6,7-tetramethoxyanthracene 1 (1.6 g, 4.9 mmol) under nitrogen atmosphere. Anhydrous dichloromethane (40 mL) was then added, and 21.6 mL of a 1.0 M BBr₃ solution in anhydrous dichloromethane (5.412 g, 21.6 mmol) was injected quickly into the suspension. The reaction mixture was stirred at room temperature for 2 h. turned brown/yellow. The solution was filtered, washed with deionized water, and dried at 80° C. overnight to yield yellow powder 2 (1.08 g, 82%). ¹H NMR (400 MHz, DMSO-d₆): δ=9.47 (s,4H), 7.32 (s, 4H), 2.68 (s, 6H). ¹³C NMR (100 MHz, DMSO-d₆): δ=145.98, 125.32, 121.07, 105.66, 14.25. HRMS (ESI-TOF): m/z Calcd for C₁₆H₁₄O₄: [M]⁻ 269.0814, found 269.0812.

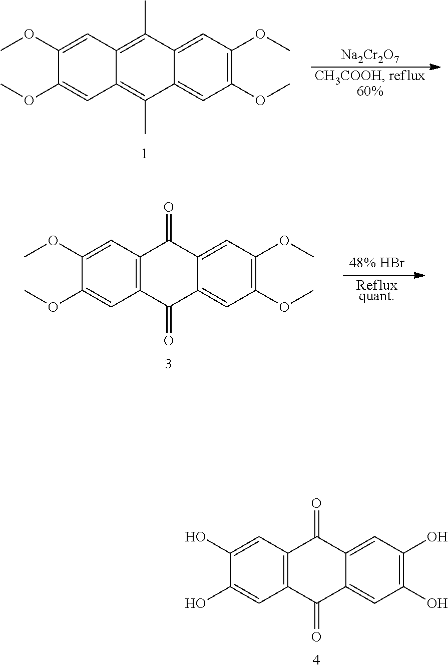

Synthetic route of 2,3,6,7-Tetrahydroxy-9,10-anthraquinone (4).

2,3,6,7-Tetramethoxy-9,10-anthraquinone (3). A mixture of finely powdered 9,10-Dimethyl-2,3,6,7-tetramethoxyanthracene 1 (5.0 g, 15 mmol), sodium dichromate (25 g, 95 mmol) and 250 mL acetic acid were refluxed for 60 min. After the solvent was cooled to room temperature, the precipitate filter washed with water and dried to give yellow powder 3 was obtained (3 g, 60%). ¹H NMR (400 MHz, CDCl₃): δ=7.68 (s, 4H), 4.05 (s, 12H). ¹³C NMR (100 MHz, CDCl₃): δ=182.15, 153.59, 128.59, 108.53, 56.69. HRMS (ESI-TOF): m/z Calcd for C₂₀H₂₂O₄: [M+Na]⁺ 351.0845, found 351.0852.

2,3,6,7-Tetrahydroxy-9,10-anthraquinone (4). 2,3,6,7-Tetramethoxy-9,10-anthraquinone 3 (2.5 g, 7.63 mmol) and 48% HBr were heated under reflux (oil bath temp. 150° C.) for 3 days. After the first 24 h, more 48% HBr (5 ml) was added through the reflux condenser to wash down some unreacted starting material that had collected there due to intense foaming and to its poor wettability. After 48 h, the yellow color had turned completely to ochre, and the foaming had stopped. After cooling, the precipitate was collected by filtration, and washed to neutral pH with dist. H₂O, and air-dried to yield brown powder 4 (2.1 g, quantitative). ¹H-NMR (400 MHz, DMSO-d₆): δ=10.45(s, 4H); 7.43 (s, 4H); 3.93 (residual H, MeO of some contaminating unhydrolyzed product). ¹³C NMR (100 MHz, DMSO-d₆): δ=181.17, 150.86, 127.11, 112.95. HRMS (ESI-TOF): m/z Calcd for C₁₄H₈O₆: [M]⁻ 271.0243, found 271.0241.

### Synthesis of DMA-Si-COFs From Silica Gel.

9,10-dimethyl-2,3,6,7-tetrahydroxyanthracene (DMA) (100 mg, 0.37 mmol), anhydrous methanol (9.5 ml), 0.55 ml of 1.0 M lithium methoxide solution in anhydrous methanol (21 mg, 0.55 mmol) and silica gel (15 mg, 0.25 mmol) were charged into a 35 mL Schlenk pressure tube. Then the Schlenk pressure tube was sonicated for around 10 min to ensure homogeneity, degassed with three cycles of freeze-pump-thaw, and then sealed. Finally, the reaction mixture was heated at 180° C. for 4 days yielding dark brown powders which were collected by filtration and washed with anhydrous acetone. The sample was dried in a vacuum oven at 80° C. for 24 h, yielding DMA-Si-COFs as black powders (0.0829 g, yield: 84%). ICP Found: 2.89 wt % (Calcd: 3.14).

Synthesis of AQ-Si-COFs from silica gel. 2,3 ,6,7-tetrahydroxyanthracene-9,10-dione (THAQ) (100 mg, 0.37 mmol), anhydrous methanol (9.5 ml), 0.55 ml of 1.0 M lithium methoxide solution in anhydrous methanol (21 mg, 0.55 mmol) and silica gel (45 mg, 0.75 mmol) were charged into a 35 mL Schlenk pressure tube. Then the Schlenk pressure tube was sonically treated for around 10 min to ensure homogeneity, degassed with three cycles of freeze-pump-thaw, and then sealed. Finally, the reaction mixture was heated at 180° C. for 4 days yielding reddish-brown powders, which was collected by filtration, and washed with anhydrous acetone. The sample was dried in a vacuum oven at 80° C. for 24 h, yielding AQ-Si-COFs as dark brown powders (0.0943 g, 96%). ICP Found: 3.45 wt % (Calcd: 3.13).

### Electrochemical Measurements

Li⁺ Conductivity (σ_{Li}_{⁺} )

Si-COFs were soaked with 1.0 M LiCO₄ in Ethylene carbonate/Diethyl carbonate (EC/DEC)=50/50 (v/v) (denoted as: Li@Si-COFs) and dried for 48 h under vacuum to remove the solvent. After that, the dry samples were mechanically pressed into solid pellets under the pressure of 10 MPa for 120 s. Then the pellet was fixed between two stainless-steel electrodes by a CR2032 coin-type cell in an argon-filled glovebox, and the EIS test was performed over the frequency ranging from 1 Hz to 10⁶ Hz with an amplitude of 100 mV. The Li⁺ transference number (t_{Li}_{⁺}) was measured using the Si-COFs/Li|Si-COFs/Li symmetric cell by potentiostatic polarization method (DC voltage: 20 mV). The temperature-dependent σ_{Li}_{⁺} (S cm⁻¹) was calculated based on the following equation:

$$σ = \frac{l}{R \times A}$$

where 1 is the thickness of the pellet (cm), R is the interfacial resistance of the pellet (Ω), and A is the area (cm²) in contact with the stainless-steel electrodes. To ensure that the battery reaches thermodynamic equilibrium, test was conducted after the cell reached the target temperature and maintained for at least half an hour. The thermal activation energy was derived from the Arrhenius relationship.

Bruce-Vincent-Evans technique

The most common experimental method for measuring t_{Li}_{⁺} in a polymer electrolyte is the so-called Bruce-Vincent method, named for the work done by Colin Vincent and Peter Bruce on this subject, published in 1987. The method involves the polarization of a symmetrical cell by a small potential difference, to induce a small concentration gradient, until the system reaches a steady state, with a concentration gradient that does not change further with time.

The t_{Li}_{⁺} was calculated by the following equation:

$${t}_{L {i}^{+}} = \frac{{i}_{s s} ( Δ V - {i}_{0} {R}_{0} )}{{i}_{0} ( Δ V - {i}_{s s} {R}_{s s} )}$$

where ΔV is the DC voltage, i₀ and i_{SS} are the values of the measured initial and steady-state current. The steady-state current is determined once the change is less than 1% for 10 minutes. R₀ and R_{SS} are initial and steady-state resistance measured by EIS.

### Cyclic Voltammetry

Analyses were performed in a standard three-electrode setup: a modified working, an Ag/AgCl reference, and a Pt foil (1 cm×1 cm) counter held in the 50 mL electrolytic cell. Before analyses, the electrolyte (1.5 M LiOH in deionized water) was purged with N₂ for 20 minutes. The base electrodes were prepared by cutting stainless steel cloth (350×350, wire diameter: 0.035 mm) into a dimension of 2 cm×2 cm. The composite electrodes were prepared by drop casting method. Si-COFs or monomer slurries that were prepared by grinding active material (72 wt. %), polyvinylidene difluoride (PVDF) (14 wt. %), and carbon black (14 wt. %) with 0.4 mL of N-methyl-2-pyrrolidone (NMP) for 30 minutes in an agate mortar and pestle. For the coating of active material, the base electrodes were dropped by the final slurries and left to dry at 100° C. overnight. The final loading was 0.01 g Si-COFs or monomers per electrode. The cyclic voltammetry (CV) measurements were performed on Autolab PGSTAT204 (Metrohm, Switzerland). The cutoff voltage of the CV test was −0.5-0.7V, and different scan rates (1, 2, 3, 4, 5 mV s⁻¹) were applied.

### Coin Cell Fabrication.

### Preparation of Si-COFs|Li Anode (Electrolyte Interphase)

2 mg Si-COFs particles were dispersed into 1 mL anhydrous 1,3-dioxolane (in an argon-filled glove box). The resulting brown suspension was ultrasonicated for 20 min to achieve homogeneity. Afterward, 50 μL, 100 μL, and 800 μL of the suspension was transferred on a Li chip (15.6 mm in diameter). Finally, the Li chip was dried in the glovebox at 65° C. overnight to form a conformal coating with a thickness of ˜15 μm, ˜35 μm, and ˜100 μm, which corresponds to ˜0.2 mg cm⁻², ˜0.4 mg cm⁻² and ˜3.2 mg cm⁻² mass loading of Si-COFs.

### Preparation of LiCoO₂ Cathode

The LiCoO₂ electrodes were prepared by the drop-casting method. LiCoO₂ slurries were designed by grinding active material LiCoO₂ powder (85 wt. %), PVDF (7.5 wt. %), and carbon black (7.5 wt. %) with 1 mL of NMP for 30 minutes in an agate mortar and pestle. For the active material coating, the base electrodes were dropped by the final slurries on the aluminum foil substrate. (Diameter: 14 mm) and left to dry at 100° C. overnight. The last loading was 0.002 g LiCoO₂ per electrode.

### Preparation of Si-COFs Cathode

The base electrodes were prepared by cutting stainless steel cloth (350×350, wire diameter: 0.035 mm) into a diameter of 14 mm. The composite electrodes were prepared by the drop-casting method. Si-COFs slurries were prepared by grinding active material (72 wt. %), PVDF (14 wt. %), and carbon black (14 wt. %) with 0.4 mL of NMP for 30 minutes in an agate mortar and pestle. For the coating of active material, the base electrodes were dropped by the final slurries and left to dry at 100° C. overnight. The final loading was 0.001 g Si-COFs per cathode.

### Measurements

### The Specific Capacity of AQ-Si-COFs and DMA-Si-COFs

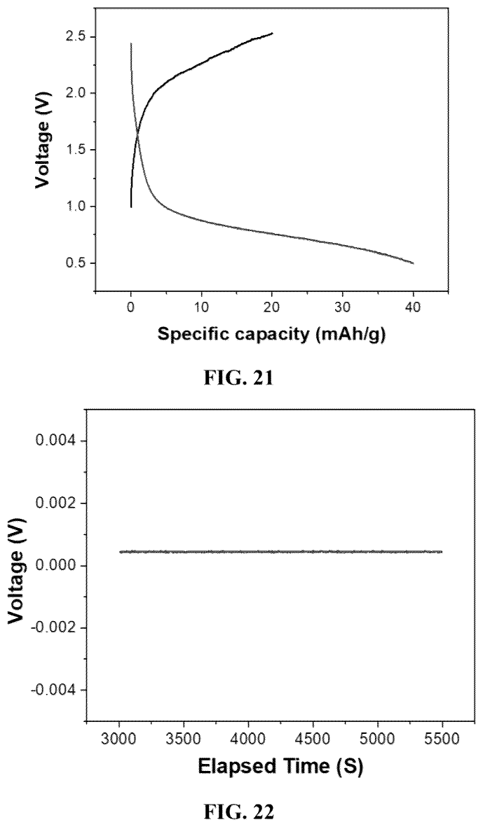

The Li metal cells were made by Li foil anodes (15.6 mm, 0.45 mm) and AQ-Si-COFs or DMA-Si-COFs composite cathodes. Polypropylene membrane (Celgard, 25 μm) was used as a separator, and 60 μL of 1.0 M LiPF₆ in EC/DEC (Sigma Aldrich) was used as an electrolyte for all cell tests. The voltage window for the cells with composite cathodes was set from 0.01 to 4.5 V. All cells were assembled in an argon-filled glove box, and the tests were conducted at ambient temperature. The performances of Si-COFs on the different substrates showed that the stainless-steel mesh was much better than the aluminum foil with a more homogeneous and stable surface, on which Si-COFs did not fall off during the cycles (FIG. 21). In addition, the pure stainless steel mesh substrate showed no activity for galvanostatic charge-discharge response (FIG. 22).

### AQ-Si-COFs and DMA-Si-COFs as the Electrolyte Interphase on the Li Anode

The Li metal cells were made by Li foil anodes (15.6 mm, 0.45 mm) with or without Si-COFs coating and LiCoO₂ cathodes. Polypropylene membrane (Celgard, 25 μm) was used as a separator, and 60 μL of 1.0 M LiPF₆ in EC/DEC (Sigma Aldrich) was used as an electrolyte for all cell tests. The voltage window for the cells with LiCoO₂ cathodes was set from 3.0 to 4.5 V. All cells were assembled in an argon-filled glove box, and the tests were conducted at ambient temperature.

### Theoretical Specific Capacity Calculation

Theoretical capacity was calculated by the following equation:

$$Capacitance = ( \frac{mAh}{g} ) ( \frac{nF}{M w ( 3.6 )} ) ( \frac{\frac{c}{mol}}{\frac{g}{mol}} ) \times \frac{1 mAh}{3.6 C}$$

where n is the number of electrons transferred per redox reaction. F is the Faraday constant, and Mw is the molar weight of the repeat unit of the organic component.

The repeating unit in AQ-Si-COFs consists of ½ of an AQ unit and ⅓ of a Silicate unit. Hence, the molecular weight of the repeating unit cell in AQ-Si-COFs is 145.3 g/mol (C₇H₄Si_{1/3}O₃). The number of electrons (n) involved in the repeating unit is equal to 1.67; therefore, using Equation, the theoretical capacity of AQ-Si-COFs is calculated to be 369.0 mAh g⁻¹.

What is claimed is:

1. An anthraquinone-based covalent organic framework (AQ-COF) comprising a first repeating unit and a second repeating unit, wherein the first repeating unit comprises a moiety of Formula 1: 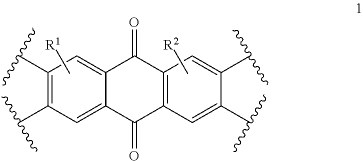
or a reduced form thereof, wherein each of R¹ and R² is independently hydrogen, C₁-C₃ alkyl, halide, nitro, or nitrile; and the second repeating unit comprises a moiety for Formula 2: 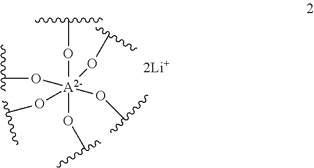
or a reduced form thereof, wherein A is Si or Ge.

2. The AQ-COF of claim 1, wherein the first repeating unit and the second repeating unit are present in the AQ-COF in a ratio of 1:1.9 to 1:2.1, respectively.

3. The AQ-COF of claim 1, wherein each of R¹ and R² is independently hydrogen, fluoride, nitro, or nitrile.

4. The AQ-COF of claim 1, wherein each of R¹ and R² is hydrogen.

5. The AQ-COF of claim 1, wherein A is Si.

6. The AQ-COF of claim 1, wherein the reduced form of the moiety of Formula 1 further comprises one electron and one Li⁺ or two electrons and two Li⁺.

7. The AQ-COF of claim 1, wherein the reduced form of the moiety of Formula 2 further comprises one electron and one Li⁺, two electrons and two Li⁺, or three electrons and three Li⁺.

8. The AQ-COF of claim 1, wherein the AQ-COF comprises a repeating unit of Formula 3: 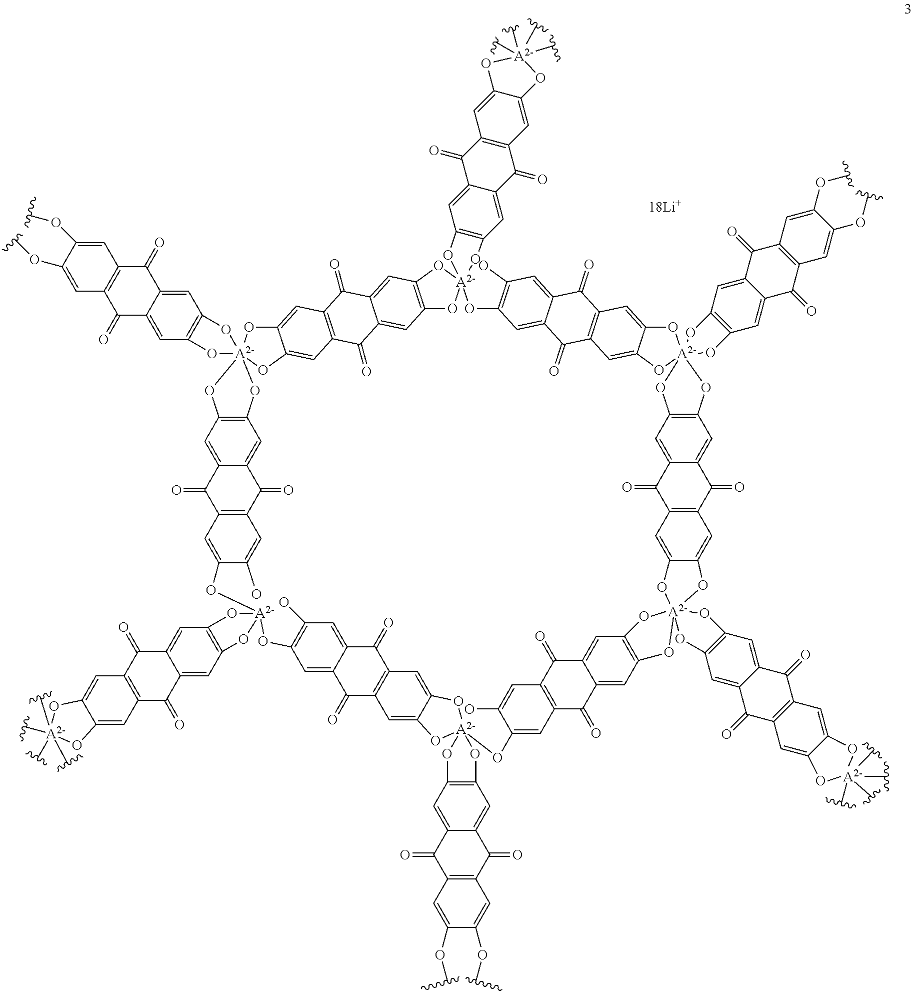
or a reduced form thereof, wherein A is Si or Ge

9. The AQ-COF of claim 8, wherein A is Si.

10. A method of preparing the AQ-COF of claim 1, wherein the method comprises:
contacting AO₂, wherein A is Si or Ge;
a compound of Formula 4: 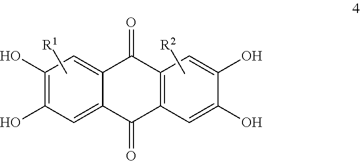
or a conjugate salt thereof, wherein each of R¹ and R² is independently hydrogen, C₁-C₃ alkyl, halide, nitro, or nitrile; and optionally a Brønsted base; thereby forming the AQ-COF.

11. The method of claim 10, wherein the Brønsted base is a lithium C₁-C₃ alkoxide.

12. The method of claim 10, wherein the step of contacting AO₂, the compound of Formula 4, and optionally a Brønsted base is conducted in an alcoholic solvent.

13. The method of claim 12, wherein A is Si, each of R¹ and R² is hydrogen, the Brønsted base is LiOMe, and the alcoholic solvent comprises methanol.

14. A solid electrolyte interphase comprising the AQ-COF of claim 1, a lithium salt, and a non-aqueous liquid electrolyte solvent.

15. The solid electrolyte interphase of claim 14, wherein the lithium salt comprises LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, or a mixture thereof.

16. The solid electrolyte interphase of claim 14, wherein the non-aqueous liquid electrolyte solvent comprises ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, gamma butyrolactone, gamma valerolactone, 1,2-dimethoxyethane, tetrahydrofuran, 2-methyltetrahydrofuran, 1,3-dioxolane, dioxane, or a mixture thereof.

17. The solid electrolyte interphase of claim 14, wherein A is Si and each of R¹ and R² is hydrogen.

18. The solid electrolyte interphase of claim 17, wherein the lithium salt comprises LiPF₆ or LiClO₄ and the non-aqueous liquid electrolyte solvent comprises ethylene carbonate (EC) and diethyl carbonate (DEC).

19. An electrochemical device comprising: the solid electrolyte interphase of claim 14, a positive electrode, and a negative electrode, wherein the solid electrolyte interphase is disposed between the positive electrode and the negative electrode.

20. The electrochemical device of claim 19, wherein A is Si and each of R¹ and R² is hydrogen.
